(19) United States
(12) Patent Application Publication
(10) Pub. No.: US 2013/0272740 A1
(43) Pub. Date: Oct. 17, 2013

(54) OPTICAL SENSOR AND IMAGE FORMING APPARATUS

(71) Applicant: CANON KABUSHIKI KAISHA, Tokyo (JP)

(72) Inventors: Ken Nakagawa, Yokohama-shi (JP); Daisuke Kaneko, Suntou-gun (JP)

(21) Appl. No.: 13/915,926

(22) Filed: Jun. 12, 2013

Related U.S. Application Data
(63) Continuation of application No. PCT/JP2013/000731, filed on Feb. 12, 2013.

(30) Foreign Application Priority Data
Feb. 13, 2012 (JP) 2012-028288
Jan. 30, 2013 (JP) 2013-015922

(51) Int. Cl. G01N 21/55

(52) U.S. Cl. CPC G01N 21/55
USPC 399/74; 250/216; 250/578.1; 250/225

(57) ABSTRACT

The optical sensor includes a light-emitting element configured to emit light to a light emitted surface, a light-receiving element configured to receive reflection light from the light emitted surface, the reflection light including light emitted from the light-emitting element and reflected at the light emitted surface, a circuit board including a mounting surface on which the light-emitting element and the light-receiving element are mounted, and a housing fixed to the circuit board. The housing includes a light shielding portion provided between the light-emitting element and the light-receiving element, and the light shielding portion is engaged with a hole formed in the circuit board at a position between the light-emitting element and the light-receiving element.

### CROSS-REFERENCE TO RELATED APPLICATIONS

This application is a continuation of International Application No. PCT/JP2013/000731, filed Feb. 12, 2013, which claims the benefit of Japanese Patent Application No. 2012-028288, filed Feb. 13, 2012 and Japanese Patent Application No. 2013-015922, filed Jan. 30, 2013.

### BACKGROUND OF THE INVENTION

1. Field of the Invention

The present invention relates to an optical sensor that emits light from a light-emitting element to a light emitted surface of an object to be measured, on which a toner is adhered, and detects reflection light from the light emitted surface by a light-receiving element. Further, the present invention relates to an image forming apparatus including the optical sensor.

2. Description of the Related Art

Currently, a printer is rapidly widespread as an image output terminal along with development of the computer network technology. In recent years, development of the color image output has been increasing demands for enhancement of image stability of a color printer and achievement of uniform color image quality between color printers.

In particular, regarding color reproducibility and superimposing accuracy of each color, high stability is demanded irrespective of change of the installed environment, change over time, or individual difference of the apparatus. However, in an electrophotographic image forming apparatus, image density and color registration are changed due to the change of the environmental condition in which the apparatus is installed, the change of the photosensitive member and the developer over time, and the temperature change in the apparatus, and hence such a high demand cannot be met with the initial setting as it is.

To cope with this problem, a toner detection device that performs feedback control to maintain the image density and the color registration in optimum states is generally employed. This feedback control is performed as follows. A test toner image (hereinafter referred to as “test pattern”) is formed on a circulatory moving member such as a photosensitive member, an intermediate transfer member, or a transfer conveying belt, and density and relative position of the test pattern are measured with an optical sensor as the toner detection device.

Based on the measurement result and the condition at the time when the test pattern is formed, the image density and the color registration are controlled so that the image density and the color registration at the time of actual printing are adjusted to appropriate levels. Parameters to be controlled include an exposure pattern at the time of forming a latent image, an exposure start position, a magnification of forming an image, a developing bias, a charging bias, and the like.

As such a toner detection device, a sensor that emits light to the test pattern and optically measures a toner amount or a position of a toner image based on the light reflected from the test pattern is often used. Infrared light is often used as the emission light, and when the infrared light is used, reflection characteristics differ depending on the type of chromatic material of the toner.

Specifically, the light intensity of the reflection light optically obtained differs between a black toner that absorbs the infrared light and a color toner that reflects the infrared light even with the same toner amount, and hence efforts are made to perform accurate measurement in both cases. In order to perform accurate detection for both the color toner and the black toner, for example, a method of detecting the toner amount (i.e., developer density) by using a sensor that detects regular reflection light and diffused reflection light is disclosed in Japanese Patent Application Laid-Open No. 2006-267644.

Japanese Patent Application Laid-Open No. 2006-267644 describes an optical sensor which includes, as optical elements, a light-emitting element (LED) that emits light to a light emitted surface of an object to be measured, a light-receiving element that receives the regular reflection light, and a light-receiving element that receives the diffused reflection light. Each of the light-emitting element and the light-receiving elements is a so-called “shell-type” optical element, and the optical sensor further includes a semiconductor chip including a light-emitting portion and light-receiving portions, a shell-type lens portion, and a lead frame connected to a circuit board. This shell-type optical element is configured to freely change a direction of the element to some extent by changing an angle of bending the lead frame. Therefore, in Japanese Patent Application Laid-Open No. 2006-267644, each of the optical elements is engaged with a housing, and then the direction of each of the optical elements is adjusted to a desired direction.

However, the shell-type optical element includes the lens portion and the lead frame that is long enough to change the direction of the element, and hence it requires a predetermined volume from the semiconductor chip to the circuit board, which is disadvantageous in terms of downsizing the sensor.

In order cope with this problem, in order to downsize the sensor itself, Patent Japanese Patent Application Laid-Open No. 2006-208266 discloses an optical sensor which employs an optical element of a chip component that is a type mounted on the surface of the circuit board. In this manner, when an optical element of a type that is directly mounted on the surface (mounting surface) of the circuit board is used, there are no lead frame and lens portion, and hence the volume required to directly mount the optical element on the circuit board is considerably reduced, enabling downsizing of the sensor.

However, the optical sensor in which the optical element of the chip component is directly mounted on the surface (mounting surface) of the circuit board, such as the optical sensor described in Patent Japanese Patent Application Laid-Open No. 2006-208266, cannot be fixed by engaging the optical element with a housing that is separately provided from the circuit board. For this reason, disturbance light is likely to be generated due to a leakage of the light occurring in the circuit board or between the circuit board and the housing, which necessitates a light shielding mechanism. To cope with this problem, an object of the present invention is to improve the light shielding effect in the optical sensor in which the optical element is mounted on the surface (mounting surface) of the circuit board.

### SUMMARY OF THE INVENTION

A purpose of the present invention is to provide improvement of the light shielding effect in the optical sensor in which the optical element is mounted on the surface mounting surface of the circuit board.

Another purpose of the invention is to provide an optical sensor, including a light-emitting element configured to emit light to a light emitted surface, a light-receiving element configured to receive reflection light from the light emitted surface, the reflection light receiving light emitted from the light-emitting element and reflected at the light emitted surface; a circuit board including a mounting surface on which the light-emitting element and the light-receiving element are mounted, and a housing fixed to the circuit board, in which the reflection light enters the light-receiving element from the light emitted surface without passing through a lens, optical axes of the light-emitting element and the light-receiving element are perpendicular to the mounting surface; the housing includes a light shielding portion provided between the light-emitting element and the light-receiving element; and the light shielding portion is engaged with a hole formed in the circuit board at a position between the light-emitting element and the light-receiving element.

A further purpose of the present invention is to provide an optical sensor, including a light-emitting element configured to emit light to a light emitted surface; a first light-receiving element and a second light-receiving element configured to receive reflection light from the light emitted surface, the reflection light including light emitted from the light-emitting element and reflected at the light emitted surface, a circuit board including a mounting surface on which the light-emitting element, the first light-receiving element, and the second light-receiving element are mounted; and a housing fixed to the circuit board, in which the reflection light enters the first light-receiving element and the second light-receiving element from the light emitted surface without passing through a lens, optical axes of the light-emitting element, the first light-receiving element, and the second light-receiving element are perpendicular to the mounting surface; and the housing includes light shielding portions provided between the light-emitting element and the first light-receiving element and between the first light-receiving element and the second light-receiving element.

A still further purpose of the present invention is provide an optical sensor, including a light-emitting element configured to emit light to a light emitted surface, a first light-receiving element and a second light-receiving element configured to receive reflection light from the light emitted surface, the reflection light including light emitted from the light-emitting element and reflected at the light emitted surface, a circuit board including a mounting surface on which the light-emitting element, the first light-receiving element, and the second light-receiving element are mounted, and a housing fixed to the circuit board, in which the reflection light enters the first light-receiving element and the second light-receiving element from the light emitted surface without passing through a lens; optical axes of the light-emitting element, the first light-receiving element, and the second light-receiving element are perpendicular to the mounting surface; and the housing includes light shielding portions provided between the light-emitting element and the first light-receiving element and between the light-emitting element and the second light-receiving element.

A still further purpose of the invention will be apparent with reference to the following descriptions and the accompany drawings.

### BRIEF DESCRIPTION OF THE DRAWINGS

FIG. 1 is an explanatory cross-sectional view illustrating a configuration of an image forming apparatus including a toner detection device according to the present invention.

FIG. 2 is a block diagram illustrating a configuration of a control system of the image forming apparatus according to the present invention.

FIG. 3 is an explanatory perspective view illustrating a configuration of a toner detection device according to a first embodiment of the present invention.

FIG. 4 is an explanatory cross-sectional view illustrating the configuration of the toner detection device according to the first embodiment of the present invention.

FIG. 5A is an exploded perspective view and assembled perspective view illustrating the configuration of the toner detection device according to the first embodiment of the present invention.

FIG. 5B is an exploded perspective view and assembled perspective view illustrating the configuration of the toner detection device according to the first embodiment of the present invention.

FIG. 6 is a circuit diagram illustrating an electric circuit configuration of the toner detection device according to the present invention.

FIG. 7 is an explanatory cross-sectional view illustrating the configuration of the toner detection device according to the first embodiment of the present invention.

FIG. 8A is a graph showing an emission intensity with respect to an emission angle of a light-emitting element of the toner detection device according to the present invention.

FIG. 8B is a graph showing a light-receiving sensitivity of a light-receiving element with respect to the emission angle of the light-emitting element of the toner detection device according to the present invention.

FIG. 9 is a table showing various characteristics of the first embodiment, another embodiment of Embodiment 1, a second embodiment, and another embodiment of Embodiment 2 of the present invention.

FIG. 10 is an explanatory cross-sectional view illustrating a configuration of a toner detection device according to the another embodiment of Embodiment 1.

FIG. 11 is a graph showing relative sensitivities of a first light-receiving element that receives regular reflection light and a second light-receiving element that receives diffused reflection light with respect to an inclination angle of a circuit board with respect to a planar surface including a reflection surface of an object to be measured according to the first embodiment.

FIG. 12 is an explanatory cross-sectional view illustrating a configuration of an optical sensor that sets reference levels of the emission intensity of the light-emitting element and light-receiving sensitivity of the light-receiving elements to the regular reflection light and the diffused reflection light.

FIG. 13 is an explanatory cross-sectional view illustrating a configuration of a toner detection device according to the second embodiment of the present invention.

FIG. 14 is a graph showing relative sensitivities of a first light-receiving element that receives regular reflection light and a second light-receiving element that receives diffused reflection light with respect to an inclination angle of a circuit board with respect to a planar surface including a reflection surface of an object to be measured according to the second embodiment.

FIG. 15 is an explanatory cross-sectional view illustrating a configuration of a toner detection device according to the another embodiment of Embodiment 2.

FIG. 16 is an explanatory cross-sectional view illustrating a configuration of a toner detection device according to a third embodiment of the present invention.

FIG. 17 is an explanatory cross-sectional view illustrating a configuration of a toner detection device according to a fourth embodiment of the present invention.

FIG. 18 is an explanatory cross-sectional view illustrating a configuration of another image forming apparatus including the toner detection device according to the present invention.

### DESCRIPTION OF THE EMBODIMENTS

An image forming apparatus according to an embodiment of the present invention is described in detail below with reference to the accompanying drawings, which includes an optical sensor as a toner detection device according to the present invention.

### First Embodiment

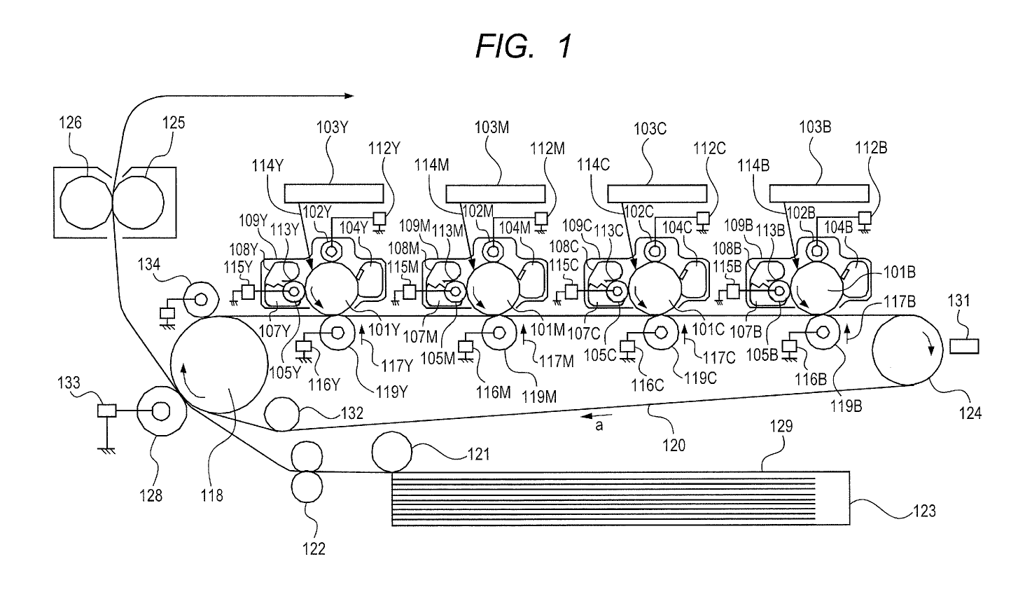

Firstly, a configuration of an image forming apparatus including a toner detection device according to a first embodiment the present invention is described with reference to FIGS. 1 to 12.

<Image Forming Apparatus>

As illustrated in FIG. 1, in this embodiment, a first station is a station for forming a toner image of a yellow (Y) color, and a second station is a station for forming a toner image of a magenta (M) color. Further, a third station is a station for forming a toner image of a cyan (C) color, and a fourth station is a station for forming a toner image of a black (K) color.

The first station includes a photosensitive drum 101Y as an image bearing member. The photosensitive drum 101Y includes a metal cylinder and multiple functional organic material layers laminated on the metal cylinder, such as a carrier generating layer that is exposed and generates a charge and a charge transport layer that transports the generated charge. The outermost layer of the photosensitive drum 101Y is a substantially insulating member having a low electrical conductivity.

A charging roller 102Y as a charging unit is brought into contact with the photosensitive drum 101Y, which uniformly charges the surface of the photosensitive drum 101Y while being rotated following a rotation of the photosensitive drum 101Y.

A direct-current voltage or a voltage obtained by superimposing an alternate-current voltage on a direct-current voltage is applied to the charging roller 102Y, and the photosensitive drum 101Y is charged by an electric discharge generated by a slight air gap on upstream and downstream sides from a contact nip portion between the charging roller 102Y and the surface of the photosensitive drum 101Y.

A cleaning unit 104Y cleans a residual toner remaining on the surface of the photosensitive drum 101Y after transfer. A developing device 108Y as a developing unit includes a developing roller 105Y, a nonmagnetic component toner 107Y, and a regulating blade 113Y.

The photosensitive drum 101Y, the charging roller 102Y, the cleaning unit 104Y, the developing roller 105Y, the toner 107Y, the regulating blade 113Y, and the developing device 108Y described above are integrated in a process cartridge 109Y that is removably mounted to an image forming apparatus 47.

An exposure device 103Y includes a scanner unit that scans laser light with a polygon mirror or a light emitting diode (LED) array. The exposure device 103Y then emits an exposure light beam 114Y that is modulated based on an image signal to the surface of the photosensitive drum 101Y.

The charging roller 102Y, the developing roller 105Y, and a primary transfer roller 119Y are respectively connected to a charging bias power supply 112Y, a developing bias power supply 115Y, and a primary transfer bias power supply 116Y. The charging bias power supply 112Y is a voltage supplying unit that supplies a voltage to the charging roller 102Y. The developing bias power supply 115Y is a voltage supplying unit that supplies a voltage to the developing roller 105Y. The primary transfer bias power supply 116Y is a voltage supplying unit that supplies a voltage to the primary transfer roller 119Y.

The above-mentioned configuration is a configuration of the first station for forming the toner image of the yellow (Y) color. The second, third, and fourth stations have the same configuration, and a component having the same function as that of the first station is assigned with the same reference symbol, and at the end of the reference symbol, M indicating the magenta color, C indicating the cyan color, or K indicating the black color is suffixed for each station. Further, each component may be hereinafter described with the reference symbol of only numbers omitting Y, M, C, and K in a representative manner.

A belt 120 as an object to be measured, which is an intermediate transfer belt formed of an endless belt on which a toner image is formed, is supported by three rollers as stretching members including a secondary transfer facing roller 118, a tension roller 124, and an auxiliary roller 132. The tension roller 124 is applied with a force in a direction of stretching the belt 120 by a biasing unit such as a spring (not shown) so that an appropriate tension is maintained on the belt 120.

The secondary transfer facing roller 118 rotates by receiving rotation driving from a driving source, and thus the belt 120 looped on the outer circumference of the secondary transfer facing roller 118 is rotated. The belt 120 moves at a substantially constant velocity in a forward direction with respect to the photosensitive drum 101.

The belt 120 is rotated in a direction of an arrow “a” illustrated in FIG. 1, and the primary transfer roller 119 is arranged on the opposite side of the photosensitive drum 101 across the belt 120 and is rotated following the movement of the belt 120. A toner detection device 131 as an optical sensor is arranged at a position facing the tension roller 124, and detects a test pattern 10 on the belt 120 (on the object to be measured). By measuring a timing at which the test pattern 10 is detected, registration control for enhancing an image position accuracy at the time of forming an image is performed, or by detecting a toner density of the test pattern 10, an image density is controlled.

A neutralizing member 117 is arranged on the downstream side of the primary transfer roller 119 in the rotation direction of the belt 120. The auxiliary roller 132, the tension roller 124, the secondary transfer facing roller 118, and the neutralizing member 117 are electrically grounded.

<Image Forming Operation>

An image forming operation of the image forming apparatus 47 is described below. When receiving a print command in a standby state, the image forming apparatus 47 starts the image forming operation. The photosensitive drum 101, the belt 120, and the like start rotating in the direction of the arrow illustrated in FIG. 1 at a predetermined process speed. The photosensitive drum 101 is uniformly charged by the charging roller 102 and the charging bias power supply 112, and then an electrostatic latent image is formed on the photosensitive drum 101 based on image information by the exposure light beam 114 from the exposure device 103.

The toner 107 in the developing device 108 is charged in the negative polarity by the regulating blade 113 and applied on the developing roller 105. A bias voltage of −300 V is supplied to the developing roller 105 from the developing bias power supply 115. When the electrostatic latent image formed on the surface of the photosensitive drum 101 reaches the developing roller 105 by the rotation of the photosensitive drum 101, the electrostatic latent image is visualized by the toner of the negative polarity.

A toner image of the first color (yellow (Y) in this embodiment) is then formed on the surface of the photosensitive drum 101. The other stations of the magenta (M), the cyan (C), and the black (K) operate in the same manner. In accordance with a distance between the primary transfer positions of the respective colors, for each of the colors, an electrostatic latent image is formed on the photosensitive drum 101 by the exposure while delaying a write signal from a controller at predetermined timings. A direct-current (DC) bias voltage of the opposite polarity to the toner is then applied to the primary transfer roller 119. With these processes, the toner images of the respective colors are sequentially transferred onto the belt 120 so that multiple toner images are formed on the belt 120.

Thereafter, in accordance with the formation of the toner image, a sheet 129 placed on a sheet cassette 123 is picked up by a feed roller 121, and conveyed to a pair of registration rollers 122 by a conveying roller (not shown). The sheet 129 is then conveyed to a transfer nip portion that is a contact portion between the belt 120 and a secondary transfer roller 128 by the pair of registration rollers 122 in synchronization with the toner image on the belt 120.

A bias of the opposite polarity to the toner is applied to the secondary transfer roller 128 by a secondary transfer bias power supply 133 so that the multiple toner images of four colors borne on the belt 120 are secondarily transferred onto the sheet 129 in a collective manner.

On the other hand, after the secondary transfer is completed, a secondary transfer residual toner remaining on the belt 120 is charged by a residual toner charging roller 134 that is arranged in contact with the belt 120.

The secondary transfer residual toner that is charged is moved to the image forming station while remaining on the belt 120, reverse transferred to the photosensitive drum 101, and collected in a waste toner container provided in the cleaning unit 104 of the image forming station.

The sheet 129 after the secondary transfer is completed is conveyed to a fixing device that includes a heating roller 125 and a pressure roller 126, and heated and pressed by the fixing device so that the unfixed toner image is fixed onto the sheet 129. Then, the sheet 129 is discharged to outside of the image forming apparatus 47.

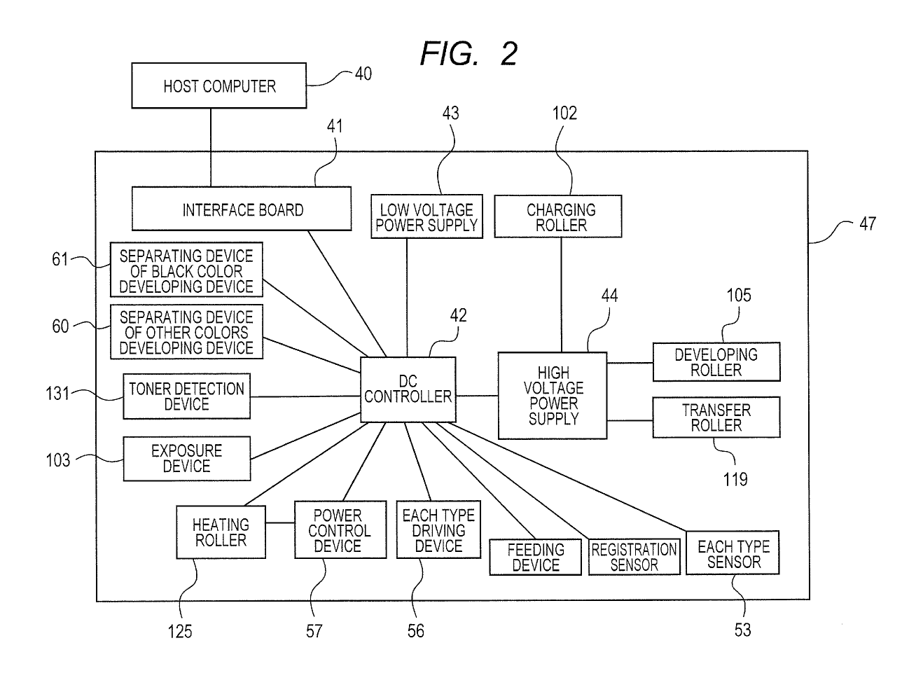

FIG. 2 is a block diagram illustrating a configuration of a control system of the image forming apparatus 47. In FIG. 2, a host computer 40 takes a role of issuing a print command to the image forming apparatus 47 and transferring image data of a print image to an interface board 41. The interface board 41 converts the image data from the host computer 40 into exposure data, and sends the print command to a DC controller 42. The DC controller 42 is operated by being supplied with a power from a low voltage power supply 43, and when receiving the print command, starts an image forming sequence while monitoring states of various types of sensors 53.

The DC controller 42 has a central processing unit (CPU), a memory, and the like (not shown) mounted thereon, and performs an operation that is programmed in advance. Specifically, the DC controller 42 controls operations of various types of driving devices 56 such as a main motor, driving devices of the developing device 108 and the photosensitive drum 101, and the like in synchronization with outputs from the various types of sensors 53 and an internal timer. Further, the DC controller 42 controls operations of a separating device 61 of the black color developing device and separating devices 60 of the other color developing devices by identifying a color mode and a monochrome mode. In addition, the DC controller 42 performs control of a high voltage power supply 44 with a control voltage, a control current, and a timing that are programmed in advance while monitoring applying voltages and currents of multiple high voltage power supplies included in the high voltage power supply 44.

Various functional components that control the image formation are connected to the high voltage power supply 44. The charging roller 102 included in each image forming station takes a role of receiving a high voltage from the high voltage power supply 44 and charging the surface of the photosensitive drum 101 to a uniform potential by being brought into contact with or in close proximity to the photosensitive drum 101 of each image forming station. Control of this charging potential is performed by the DC controller 42 controlling the high voltage generated in the high voltage power supply 44. Similarly, high voltages are supplied from the high voltage power supply 44 to the developing roller 105 included in each image forming station and the transfer roller 119 included in each image forming station, and the applying voltage and the applying current are controlled by the DC controller 42 so that an appropriate transfer characteristic is obtained.

Further, the DC controller 42 performs power control so that a temperature of the heating roller 125 is maintained at a predetermined temperature by controlling a power control device 57 connected to the heating roller 125.

<Calibration>

Calibration (automatic correction control) of the image forming apparatus 47 is described below. The calibration is roughly divided into two types including registration control and toner image density control. These controls are performed by forming the test pattern 10 including a test toner image on the belt 120 and detecting the test pattern 10 with the toner detection device (optical sensor) 131 that is described later. Firstly, the registration control is described.

In the registration control, the test pattern 10 including a toner image of at least two rows for detecting a color misregistration for each color is formed on the belt 120 (light emitted surface). As illustrated in FIG. 1, arrival of the test pattern 10 at a position of the toner detection device 131 is detected by at least two toner detection devices (optical sensors) 131 described later, which are provided on both sides of a downstream portion of the belt 120, and a result of the detection is output to the DC controller 42. The DC controller 42 detects a passing timing of the test pattern 10 based on the output from the toner detection device 131, and calculates relative color misregistration amounts in a main scanning direction and a sub-scanning direction between the colors, a main scanning magnification, a relative inclination, and the like by comparing the detected passing timing with a predetermined timing. In response to a result of the calculation, correction of the color misregistration of the output image is performed so that the relative color misregistration amount of each color is decreased.

The misregistration of the image is corrected as follows. The misregistration of the image can be corrected by controlling an exposure timing of the exposure device 103. Specifically, the DC controller 42 performs control of the exposure device 103 so that a scanning speed becomes a predetermined value and an exposure amount becomes a predetermined value, and concurrently corrects the color misregistration by adjusting a write timing. For example, in the case of the image forming apparatus 47 that includes the exposure device 103 of a polygon mirror type, at the time of forming an image, the DC controller 42 generates an image leading edge signal by counting write start reference pulses from the exposure device 103 and sends the generated image leading edge signal to the interface board 41.

The exposure data is sent to the exposure device 103 from the interface board 41 via the DC controller 42 for each line (each surface of the polygon mirror) in synchronization with the image leading edge signal. The write timing of each line can be changed by an amount corresponding to several dots by changing the timing at which the DC controller 42 issues the image leading edge signal by a period of time corresponding to several dots for each image forming station. Thus, it is possible to adjust a write position in the main scanning direction perpendicular to the conveying direction of the sheet 129. In addition, the entire image can be shifted by one line in the conveying direction of the sheet 129 with a delay of the write timing by one line, for example, and hence the write position in the sub-scanning direction that is the conveying direction of the sheet 129 can be adjusted by units of line.

Further, positioning in the sub-scanning direction on a level less than one line can be performed by controlling a rotation phase difference of the polygon mirror, which is a polygon mirror of the scanner included in the exposure device 103, between the image forming stations. Moreover, correction of the main scanning magnification can be performed by changing a clock frequency that serves as a reference for the on/off operation of the exposure data.

In this manner, regarding the color misregistration between the image forming stations, the color misregistration amount (registration) can be corrected by detecting the relative color misregistration amount based on the output of the above-mentioned toner detection device (optical sensor) 131 and adjusting the image forming (exposure start) timing and the reference clock for the exposure through the control of the exposure device based on the relative color misregistration amount.

<Toner Image Density Control>

The toner image density control is described below. One of the problems in the electrophotographic image forming apparatus 47 is that the toner image density is changed due to humidity and temperature conditions under which the image forming apparatus 47 is used and a usage frequency of the image forming station of each color. In order to correct this change, the toner image density of the test pattern 10 is detected, and control of image forming parameters is performed so that a desired characteristic is obtained. In order to measure the toner image density, the test pattern 10 including a detection toner image of each color is formed on the outer circumferential surface of the belt 120 and this test pattern 10 is read by the toner detection device 131.

When the toner image density detection is started, the central processing unit (CPU) in the DC controller 42 sets density parameters such as the charging voltage, the developing voltage, and the exposure amount to specific values and starts printing the test pattern 10. The test pattern 10 is generated by a personal computer (PC) if the printer is a host-based printer, and is formed by the exposure device 103 via the exposure control device at a predetermined timing controlled by the CPU in the DC controller 42. Depending on the case, the test pattern 10 may be generated by the DC controller 42.

In this manner, the test pattern 10 formed on the outer circumferential surface of the belt 120 is detected by the toner detection device (optical sensor) 131 that is described later. The output of the toner detection device is then processed by the DC controller 42. A light-receiving amount signal of the toner detection device 131 is subjected to analog-to-digital (A/D) conversion, output to the DC controller 42, and processed by the CPU in the DC controller 42 so that a value corresponding to the toner image density is calculated (the toner density is detected). Each toner image density parameter is determined based on a result of the calculation. Depending on the case, the above-mentioned toner image density detection is repeated with a newly set toner image density parameter to optimize each toner image density parameter.

A result of setting the toner image density parameters is stored in the memory of the DC controller 42, and is used at the time of the normal image forming operation and at the time of the next toner image density detection.

In this manner, image forming process conditions such as the high voltage condition and the laser power are adjusted based on the output from the toner detection device (the result of the toner image density detection is fed back). With this operation, the maximum density of each color is adjusted to a desired value and an appropriate developing condition is set so that a defect referred to as a “fogging”, in which an unnecessary toner is adhered to a white portion, can be prevented. In addition, the above-mentioned toner image density control has high significance in maintaining a color balance of each color to be constant, and at the same time, preventing a fixing failure and scattering of a character of the superimposed colors due to an excess toner.

<Toner Detection Device>

The toner detection device (optical sensor) 131 that detects the test pattern 10 is described below.

According to this embodiment, two toner detection devices 131 are arranged in a row in a depth direction of FIG. 1 (an axis direction of the tension roller 124) while facing the tension roller 124 across the belt 120.

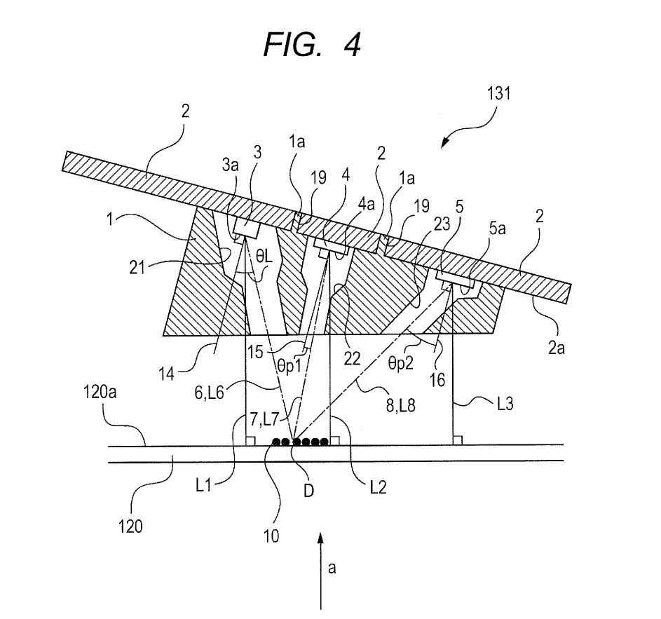

FIG. 4 is a cross-sectional view of the toner detection device 131 according to this embodiment. The toner detection device 131 includes a light-emitting element 3 that emits light to a target detection portion (light emitted surface) D of the outer circumferential surface of the belt 120 that is an object to be measured on which the toner 107 is adhered. Further, the toner detection device 131 includes a first light-receiving element 4 that receives regular reflection light from the target detection portion D and a second light-receiving element 4 that receives diffused reflection light from the target detection portion D.

The light-emitting element 3 includes a light emitting diode (LED), and is directly mounted on a surface (mounting surface 2a) of a circuit board 2. An infrared light emitting diode SIM-030ST manufactured by ROHM Co., Ltd. is used as the light-emitting element 3 according to this embodiment. However, other types of light-emitting elements may be used. The light-receiving elements 4 and 5 are photodiodes having a sensitivity on a wavelength of the light emitted from the light-emitting element 3. An infrared light emitting diode SML-810TB manufactured by ROHM Co., Ltd. is used as the light-receiving elements 4 and 5 according to this embodiment. However, other types of optical elements such as photodiodes or phototransistors may be used. The light-emitting element 3 and the light-receiving elements 4 and 5 are directly mounted (fixed) on the same mounting surface 2a of the circuit board 2.

The light emitted from the light-emitting element 3 travels in a light-guiding path 21 of a housing 1 in a direction of an optical axis line 6 and emitted to the target detection portion D of the outer circumferential surface of the belt 120. The regular reflection light reflected at the target detection portion D of the outer circumferential surface of the belt 120 generally travels in a direction of an optical axis line 7, and is guided in a light-guiding path 22 of the housing 1 to arrive at the light-receiving element 4 for measuring the regular reflection light. In this manner, the regular reflection light is detected by the light-receiving element 4.

On the other hand, when the test pattern 10 including the toner image is formed on the target detection portion D of the outer circumferential surface of the belt 120, the emission light emitted from the light-emitting element 3 is diffusedly reflected by the test pattern 10 on the target detection portion D of the outer circumferential surface of the belt 120. A part of the reflection light is reflected in the direction of the optical axis line 7 and arrives at the light-receiving element 4, and the rest of the reflection light is reflected in a direction of an optical axis line 8 and arrives at the light-receiving element 4 for measuring the diffused reflection light. In this manner, the reflection light is detected by the light-receiving elements 4 and 5.

Further, the light-emitting element 3 and the light-receiving elements 4 and 5 are not the types that are fixed (mounted) on the circuit board with a lead pin extending from the element such as the shell-type optical element described above, but are so-called “bare chip type components”, in which a semiconductor chip component is directly mounted on the surface (mounting surface 2a) of the circuit board 2 (fixed in a state in which the semiconductor chip component is placed on the mounting surface 2a). Therefore, unlike the shell-type element that is fixed on the circuit board 2 with the lead pin, postures of the light-emitting element 3 and the light-receiving elements 4 and 5 cannot be changed freely. For this reason, although there is an error generated when mounting the elements on the circuit board 2, a light-emitting surface 3a of the light-emitting element 3, a light-receiving surface 4a of the first light-receiving element 4, and a light-receiving surface 5a of the second light-receiving element 5 are basically parallel to or substantially parallel to the surface (mounting surface 2a) of the circuit board 2 having the elements mounted thereon. In other words, it is assumed that a normal line 14 of the light-emitting surface 3a is the optical axis (optical center line) of the light-emitting element 3, a normal line 15 of the light-receiving surface 4a is the optical axis (optical center line) of the first light-receiving element 4, and a normal line 16 of the light-receiving surface 5a is the optical axis (optical center line) of the second light-receiving element 5. With this arrangement, the optical axes of the light-emitting element 3, the first light-receiving element 4, and the second light-receiving element 5 are perpendicular or substantially perpendicular to the surface (mounting surface 2a) of the circuit board 2.

The light-emitting element 3 and the light-receiving elements 4 and 5 are mounted on the surface of the circuit board 2 and fixed through electrical connection of the respective terminals to a wire pattern formed on the circuit board 2. General paper phenol substrates, glass epoxy substrates, and the like may be used suitably for the circuit board 2.

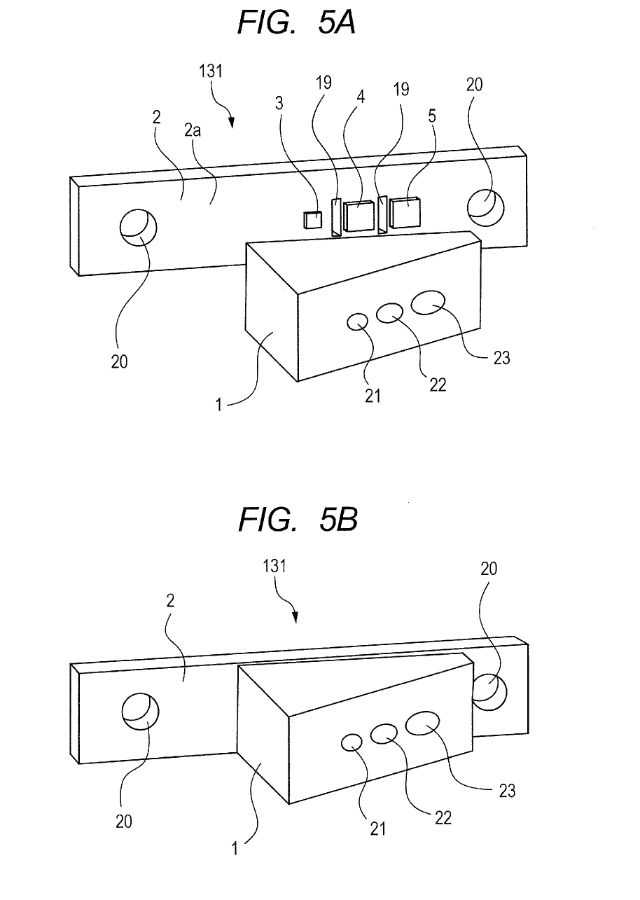

FIGS. 5A and 5B are perspective views of the toner detection device 131 according to this embodiment. FIG. 5A illustrates a state before fixing the housing 1 that is described later to the circuit board 2. The light-emitting element 3, the light-receiving element 4, and the light-receiving element 5 are mounted on the surface of the circuit board 2 by using a known reflow method.

The chip components including the light-emitting element 3 and the light-receiving elements 4 and 5 are mounted on the circuit board 2 by die bonding. Thereafter, the chip components are connected to the wire pattern on the circuit board 2 from a side of the chip surface by wire bonding using a gold wire or an aluminum wire. The chip components may be flip chip mounted on the circuit board 2 by forming a connection bump including bump-shaped terminals arranged in an array on the chip surface. As illustrated in FIG. 5A, the light-emitting element 3 and the light-receiving elements 4 and 5 are mounted on the circuit board 2 in a row.

Further, chip components (not shown) other than the optical elements such as the light-emitting element 3, the light-receiving element 4, and the light-receiving element 5 are also mounted on the circuit board 2. Those chip components are circuits having functions of controlling a current applied to the light-emitting element 3 and converting currents obtained through optical-to-electrical conversion by the light-receiving elements 4 and 5 into voltages and amplifying the converted voltages.

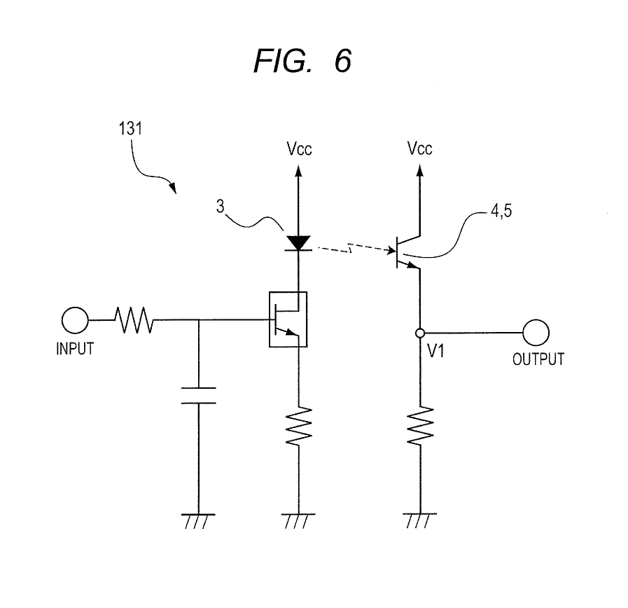

FIG. 6 illustrates an example of a circuit configuration of the toner detection device 131. The toner detection device 131 includes the light-emitting element 3 including an LED, and the light-receiving elements 4 and 5 each including a phototransistor. The light is emitted from the light-emitting element 3 to the outer circumferential surface of the belt 120, and the reflection light from the outer circumferential surface of the belt 120 is received by the light-receiving elements 4 and 5. The detection current from the light-receiving elements 4 and 5 is converted into a voltage V1 by an IV (current/voltage) conversion circuit, and input to an AD conversion port of the CPU included in the DC controller 42 illustrated in FIG. 2. An analog voltage value is then converted into digital data, and the digital data is used in the arithmetic operation.

The on/off control and the light intensity adjustment of the light-emitting element 3 are performed by varying an LED driving current input to an input terminal illustrated in FIG. 6 by pulse width modulation (PWM) control of the CPU included in the DC controller 42.

<Configuration of Housing 1>

A configuration of the housing 1 of the toner detection device is described below. FIG. 5B is a perspective view illustrating the toner detection device 131 in a state in which the housing 1 is fixed to the circuit board 2. As illustrated in FIG. 5B, the housing 1 is fixed to the circuit board 2. The housing 1 is molded using a black resin having a high light shielding effect.

The light-guiding path (first light-guiding path) 21 that is an emission hole for the light-emitting element 3 is formed in the housing 1, and the light-guiding path (second light-guiding path) 22 and a light-guiding path (third light-guiding path) 23 that are light-receiving holes for the light-receiving elements 4 and 5, respectively, are formed in the housing 1. An area of the housing 1 where the light-guiding path 21 is formed functions as an aperture for regulating the light emitted to the target detection portion D, and areas of the housing 1 where the light-guiding paths 22 and 23 are formed function as apertures for regulating the reflection light from the target detection portion D. These apertures serve to determine a light emission direction and a light-receiving direction of the toner detection device 131.

A straight line connecting a point of center of gravity of the light-emitting surface 3a of the light-emitting element 3 and a point of center of gravity of the light-guiding path 21 is defined as the optical axis line 6 of the light-emitting element 3. The optical axis line 6 is different from the optical axis (optical center line) of the light-emitting element 3 that is the normal line 14 of the light-emitting surface 3a.

That is, the optical axis line 6 is an optical axis (center light beam) of the emission light emitted from the light-emitting element 3 to the target detection portion D. Similarly, a straight line connecting a point of center of gravity of the light-receiving surface 4a of the light-receiving element 4 for the regular reflection light and a point of center of gravity of the light-guiding path (second light-guiding path) 22 is defined as the optical axis line 7 of the light-receiving element 4 for the regular reflection light. The optical axis line 7 is different from the optical axis (optical center line) of the first light-receiving element 4 that is the normal line 15 of the light-receiving surface 4a.

That is, the optical axis line 7 is an optical axis (center light beam) of the reflection light that is reflected at the target detection portion D and enters the light-receiving element 4. Similarly, a straight line connecting a point of center of gravity of the light-receiving surface 5a of the light-receiving element 5 for the diffused reflection light and a point of center of gravity of the light-guiding path (third light-guiding path) 23 is defined as the optical axis line 8 of the light-receiving element 5 for the diffused reflection light. That is, the optical axis line 8 is an optical axis (center light beam) of the reflection light that is reflected at the target detection portion D and enters the light-receiving element 5. The optical axis line 8 is different from the optical axis (optical center line) of the second light-receiving element 5 that is the normal line 16 of the light-receiving surface 5a.

When the light emitted from the light-emitting element 3 arrives at the light-receiving elements 4 and 5 through an internal side of the housing 1 and the inside of the circuit board 2 without being emitted to the outer circumferential surface of the belt 120, the light becomes disturbance light (stray light), which is not desirable because it increases a measurement error. With the shell-type optical element having a conventional configuration described in Japanese Patent Application Laid-Open No. 2006-267644, the lens portion increases the directivity, and the direction of the light emitted from the light-emitting element or the direction of the light that enters the light-receiving element can be regulated by bending the lead frame to engage the optical element with the mounting portion of the housing so that the disturbance light is hardly generated or is hardly received.

However, with the configuration in which the light-emitting element 3 and the light-receiving elements 4 and 5 are mounted on the mounting surface of the circuit board 2 and a surrounding thereof is covered by the housing 1, the light is likely to be leaked from a boundary portion between the circuit board 2 and the housing 1. In addition, there is no focusing optical element such as a lens in the optical element and the housing (the light is not emitted or received via the lens). Therefore, light having a low directivity, which does not pass through the lens or the like, is emitted from the light-emitting element, and as a result, the light is emitted in various directions in the first light-guiding path of the housing. Therefore, the light easily travels even to the boundary portion between the circuit board 2 and the housing 1. Further, there is no lens on the light-receiving side as well, and hence light from various directions is easily received so long as the light travels within the second light-guiding path or the third light-guiding path in the housing (the directivity is low). Accordingly, when there is any disturbance light traveling within the second light-guiding path or the third light-guiding path, the disturbance light is easily detected. For this reason, it is necessary to take a measure in shielding each light-guiding path in the housing.

To this end, as illustrated in FIG. 4, a wall portion (light shielding portion) 1a is projected from a fixing surface of the housing 1 on the circuit board 2 side. When fixing the housing 1 to the circuit board 2, the wall portion (light shielding portion) 1a of the housing 1 is inserted into and engaged with a slit hole 19 that is formed through the circuit board 2. With this configuration, the light emitted from the light-emitting element 3 is prevented from arriving at the light-receiving elements 4 and 5 through the inside of the housing 1 or the inside of the circuit board 2 without being emitted to the outer circumferential surface of the belt 120 so that the light becomes the disturbance light (stray light). As illustrated in FIG. 4, the wall portion 1a and the slit hole 19 are provided between the light-emitting element 3 and the light-receiving element 4 and between the light-receiving element 4 and the light-receiving element 5. Therefore, through engagement of the wall portion (light shielding portion) 1a with the slit hole 19, more secure shielding is obtained (the light is shielded from traveling) between the light-guiding path 21 and the light-guiding path 22 and between the light-guiding path 22 and the light-guiding path 23 in the housing 1.

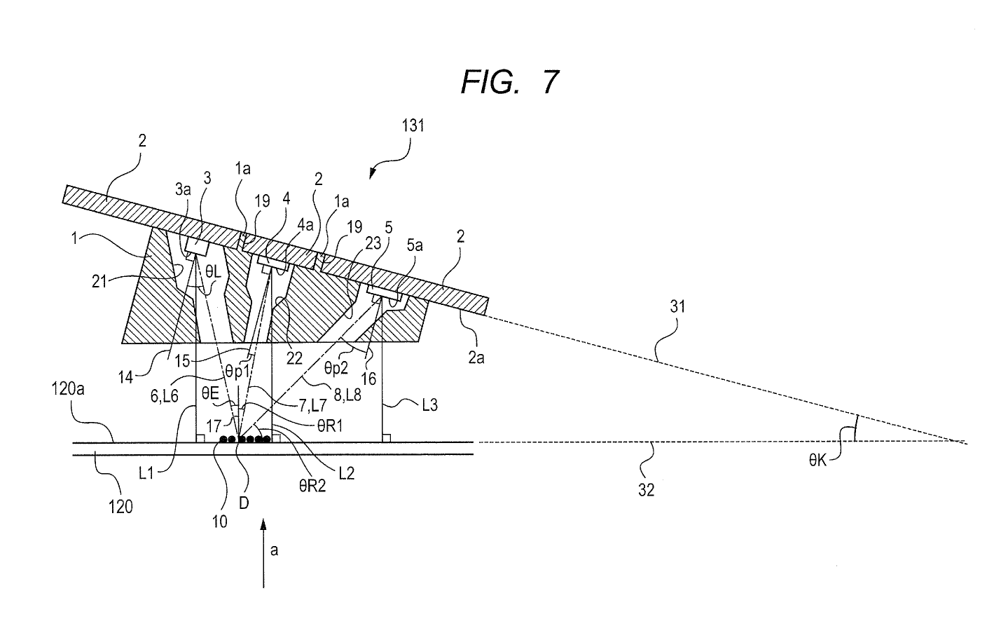

Further, as illustrated in FIG. 7, the mounting surface 2a of the circuit board 2 is arranged at an inclination angle θk with respect to a planar surface (ridge line 120a) including a reflection surface (light emitted surface) defined by the outer circumferential surface of the belt 120 in a direction in which the light-receiving element 5 for measuring the diffused reflection light is close to the belt 120. As illustrated in FIGS. 5A and 5B, a hole 20 is formed in the circuit board 2 so that the toner detection device 131 is fixed to a stay or the like of the image forming apparatus 47 with a fixing jig such as a screw (not shown).

<Arrangement of Toner Detection Device>

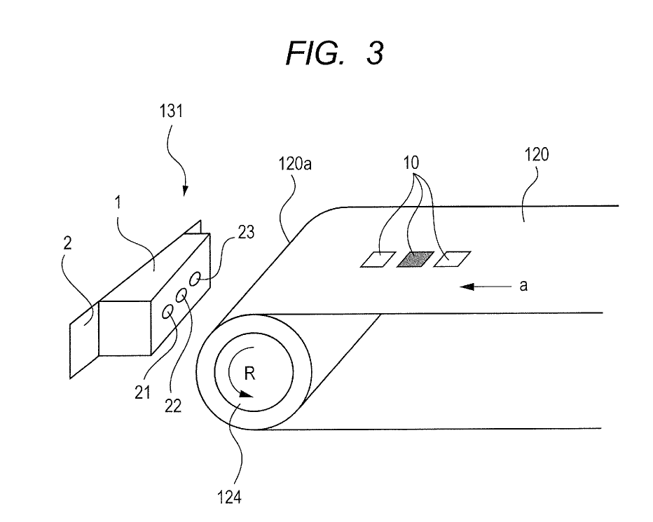

FIG. 3 is a perspective view illustrating an arrangement of the toner detection device 131 in the image forming apparatus 47 according to this embodiment.

The toner detection device 131 is arranged facing a portion where the belt 120 is looped around the tension roller 124. The toner detection device 131 is arranged facing a curved surface of a semi-cylindrical shape on the outer circumferential surface of the belt 120 looped around the tension roller 124, and the optical axis lines 6, 7, and 8 of the light-emitting element 3 and the light-receiving elements 4 and 5 are arranged toward a rotation axis center of the tension roller 124.

FIG. 4 is a cross-sectional view of a plane including the optical axis line 6 of the light-emitting element 3 and the optical axis lines 7 and 8 of the light-receiving elements 4 and 5. As illustrated in FIG. 3, the tension roller 124 is driven to rotate in a direction of an arrow “R” illustrated in FIG. 3 together with the belt 120. The test pattern 10 including the toner image is formed on the belt 120, and is moved in a direction of an arrow “a” illustrated in FIG. 3. The test pattern 10 is formed on the belt 120 when performing the calibration so that the test pattern 10 passes along the target detection portion D on the outer circumferential surface of the belt 120 to which the light from the light-emitting element 3 of the toner detection device 131 is emitted.

<Principle of Detecting Toner Image Density>

A principle of detecting the toner image density of the test pattern 10 by the toner detection device 131 is described below. The light emitted from the light-emitting element 3 is reflected with a predetermined reflectance that is determined by a unique refractive index of the material and a surface condition of the belt 120 that is a background of the test pattern 10, and the light is detected by the light-receiving elements 4 and 5.

When the test pattern 10 is formed on the belt 120, the belt 120 that is the background of the test pattern 10 is hidden in a portion having the toner so that the regular reflection light intensity from the belt 120 is decreased. In the case of the black color toner, the light intensity of the regular reflection light received by the light-receiving element 4 is decreased along with an increase of the toner amount of the test pattern 10. The density of the test pattern 10 is obtained based on a ratio of the decrease of the light intensity.

When the toner is a color toner (yellow, magenta, or cyan) other than the black color, the light intensity of the regular reflection light from the belt 120 that is the background of the test pattern 10 is equivalently decreased along with the increase of the toner amount. However, the light intensity of the diffused reflection light from the toner is increased, and a sum of both components becomes the light intensity of the regular reflection light received by the light-receiving element 4.

In order to calculate the net regular reflection light intensity from the received light intensity, the light-receiving element 5 that measures only the diffused reflection light is separately arranged. The light intensity of the light received by the light-receiving element 5 that measures only the diffused reflection light is then subtracted from the light intensity of the light received by the light-receiving element 4, which is the sum of the regular reflection light and the diffused reflection light. With this operation, the net regular reflection light intensity can be calculated. This enables the density of the test pattern 10 to be measured even for the color toner other than the black color toner.

The reflection light intensity is also changed along with a change of the surface condition of the outer circumferential surface of the belt 120 that is the background of the test pattern 10 due to the usage frequency of the belt 120 that is the object to be measured. For this reason, it is preferred that the reflection light intensity obtained when the test pattern 10 is formed on the outer circumferential surface of the belt 120 be normalized based on the reflection light intensity obtained when there is no test pattern 10 on the outer circumferential surface of the belt 120. By performing such normalization, a sufficient detection accuracy can be secured even when there is more or less a fluctuation of the light intensity of the light-emitting element 3, a fluctuation of a size of an emission spot on the target detection portion D, a fluctuation of the sensitivity of the light-receiving elements 4 and 5, contamination on the light-guiding paths 21, 22, and 23, or the like.

The test pattern 10 used in the above-mentioned calibration is formed using the toner 107 of the image forming apparatus 47. Therefore, it is preferred that the usage amount of the toner be as small as possible.

To this end, it is preferred to form the test pattern 10 as small as possible. In order for the sensor to sufficiently respond and read even the small test pattern 10, it is necessary to increase the spatial resolution and the temporal resolution of the sensor. The temporal resolution is related to a time constant of the detection circuit, and in general, higher-speed response can be expected as the sensitivity of the sensor is increased. Therefore, it is important to increase the sensitivity of the sensor.

In addition, it is known that, in the LED used for the light-emitting element 3, the temperature of a semiconductor chip inside the LED is increased due to the emission, which causes a drift phenomenon in which the optical output is fluctuated. If the sensitivity of the sensor is high, the LED can be used with a decreased driving current even when detecting the same belt 120, and hence a time required for the drift phenomenon to be converged (an influence of the drift phenomenon can be ignored) is decreased, which is preferred because the time required for the calibration can be decreased.

<Inclination of Circuit Board of Toner Detection Device>

The inclination angle θk of the mounting surface 2a of the circuit board 2 and a relationship between an angle of each of the optical axis lines 6 to 8 of the toner detection device 131 and the inclination angle θk of the mounting surface 2a of the circuit board 2, which are features of the present invention, are described with reference to FIG. 7.

As described above, the toner detection device 131 is configured to detect the regular reflection light and the diffused reflection light from the target detection portion D on the outer circumferential surface of the belt 120.

The optical axis of the emission light emitted from the light-emitting element 3 to the target detection portion D is the optical axis line 6. The emission light enters the target detection portion D along the optical axis line 6 having an angle θE with respect to the direction of a normal line 17 of the belt 120, and the emission light is reflected at the belt 120.

Regarding the detection of the regular reflection light, an angle θR1 between the optical axis line 7 of the regular reflection light and the normal line 17 of the belt 120 is the same as the angle θE. When the angle θE is changed, the regular reflection light intensity is changed due to the toner amount, i.e., the density of the test pattern 10, and in general, when the angle θE is decreased, the higher density can be measured. However, when the angle θE is too small, a space between the light-emitting element 3 and the light-receiving element 4 is decreased, thereby causing a problem in design and arrangement of the light-guiding paths 21 and 22. Therefore, it is preferred that the angle θE be about 5 degrees to 30 degrees, and in this embodiment, the angle θE is set to 15 degrees.

Further, regarding the detection of the diffused reflection light, when the regular reflection light that is obtained when the emission light from the light-emitting element 3 is reflected at the belt 120 enters the light-receiving element 5 on a side of the diffused reflection light, the diffused reflection light cannot be measured correctly. For this reason, it is necessary to secure a certain amount of angle between the optical axis line 7 and the optical axis line 8 of the diffused reflection light that enters the light-receiving element 5 on the side of the diffused reflection light. That is, it is necessary that an angle θR2 between the optical axis line 8 and the ridge line 120a of the belt 120 be set away from a value close to (90 degrees-angle θE).

In addition, even considering various fluctuations in the mounting accuracy of each element on the circuit board 2, mounting accuracy of the circuit board 2 on the image forming apparatus 47, and the like, it is preferred to set the angle θR2 with a certain amount of margin to such an angle that the regular reflection light does not enter the light-receiving element 5 on the side of the diffused reflection light. Further, when the angle θE is about 5 degrees to 30 degrees, it is difficult to arrange the light-receiving element 5 between the light-emitting element 3 and the light-receiving element 4. That is, it is difficult to obtain the condition to satisfy the relationship, θR2>(90 degrees−θE). Therefore, it is preferred to set the angle θR2 to about 35 degrees to 60 degrees, and in this embodiment, the angle θR2 is set to 45 degrees.

On the other hand, when the light-emitting element 3 of the bare chip type is used and the optical axis line 6 is determined from a relationship between the light-emitting surface 3a and the light-guiding path 21, as in this embodiment, the emission intensity is likely to be changed depending on the angle between the optical axis line 6 and the light-emitting surface 3a. This aspect is described.

In FIG. 7, reference symbol 14 indicates the normal line to the light-emitting surface 3a of the light-emitting element 3 (or a mounting surface to the circuit board 2 on the backside of the light-emitting element 3). An angle θL between the normal line 14 of the light-emitting surface 3a of the light-emitting element 3 and the optical axis line 6 is an angle that determines the emission light intensity of the toner detection device 131.

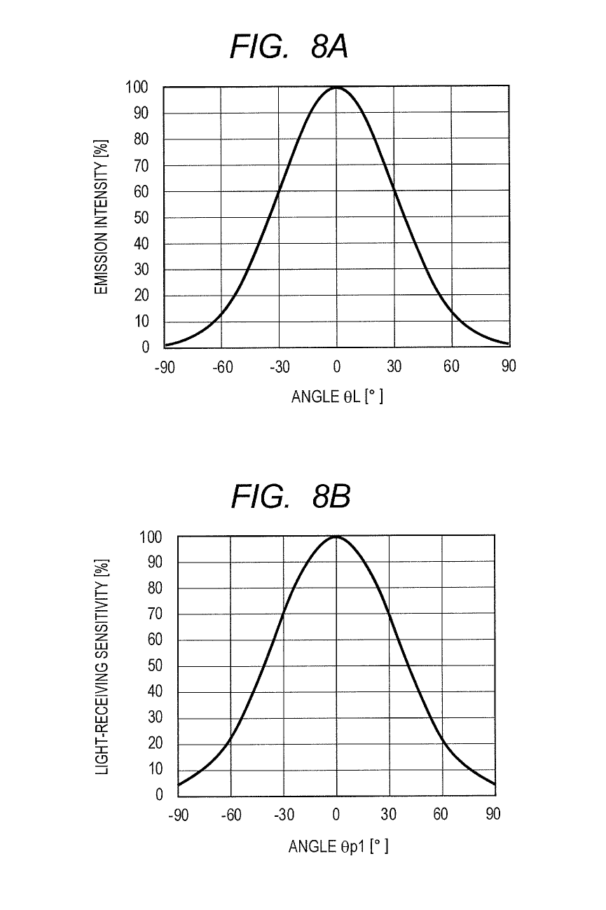

FIG. 8A is a graph showing a relationship between the angle θL between the normal line 14 of the light-emitting surface 3a of the light-emitting element 3 and the optical axis line 6 and the light intensity of the emission light emitted from the light-emitting element 3 to the target detection portion D of the outer circumferential surface of the belt 120. The vertical axis of FIG. 8A is normalized with the emission intensity set as 100% at the peak at which the normal line 14 of the light-emitting surface 3a of the light-emitting element 3 and the optical axis line 6 match each other (angle θL=0). The horizontal axis of FIG. 8A represents the angle θL between the normal line 14 of the light-emitting surface 3a of the light-emitting element 3 and the optical axis line 6, which is varied around angle θL=0 at which the optical axis line 6 and the normal line 14 of the light-emitting element 3 match each other.

As shown in FIG. 8A, it is found that, when an absolute value of the angle θL between the normal line 14 of the light-emitting surface 3a of the light-emitting element 3 and the optical axis line 6 is increased, the light intensity of the emission light emitted from the light-emitting element 3 to the target detection portion D of the outer circumferential surface of the belt 120 is significantly decreased. When the absolute value of the angle θL between the normal line 14 of the light-emitting surface 3a of the light-emitting element 3 and the optical axis line 6 is increased, the amount of the light used with respect to the current applied to the LED is decreased, resulting in degradation of the efficiency and eventually the sensitivity of the entire sensor.

Similarly, the light-receiving sensitivities of the light-receiving elements 4 and 5 are likely to be changed depending on the angles between the light-receiving surfaces 4a and 5a and the optical axis lines 7 and 8, respectively. In FIG. 7, an angle between the direction of the normal line 15 of the light-receiving surface 4a of the light-receiving element 4 for receiving the regular reflection light and the optical axis line 7 of the regular reflection light is θp1.

FIG. 8B is a graph showing a change of a photocurrent along with a change of the angle θp1 when a constant amount of light is emitted to the light-receiving element 4 at the angle θp1. The vertical axis of FIG. 8B is normalized with the photocurrent value (light-receiving sensitivity) set as 100% at the peak at which the normal line 15 of the light-receiving surface 4a of the light-receiving element 4 and the optical axis line 7 match each other (angle θp1=0). The horizontal axis of FIG. 8B represents the angle θp1 between the normal line 15 of the light-receiving surface 4a of the light-receiving element 4 and the optical axis line 7, which is varied around angle θp1=0 at which the optical axis line 7 and the normal line 15 of the light-receiving element 4 match each other. When the light-receiving element 4 is used at a large angle θp1 between the normal line 15 of the light-receiving surface 4a of the light-receiving element 4 and the optical axis line 7 of the regular reflection light, the photocurrent is decreased even when the same amount of light is received, and hence the sensitivity of the sensor is decreased.

In FIG. 7, when an angle θp2 between the normal line 16 of the light-receiving surface 5a of the light-receiving element 5 for receiving the diffused reflection light and the optical axis line 8 of the diffused reflection light is increased in the same manner as described above, the sensitivity of the sensor is decreased.

In this manner, the most ideal arrangement is obtained when the normal line 14 of the light-emitting surface 3a of the light-emitting element 3 and the optical axis line 6 match each other and the normal line 15 of the light-receiving surface 4a of the light-receiving element 4 and the normal line 16 of the light-receiving surface 5a of the light-receiving element 5 and the optical axis lines 7 and 8 match each other, respectively.

However, as described above, the light-emitting element 3 and the light-receiving elements 4 and 5 are directly mounted on the common surface of the circuit board 2. With this configuration, the postures of the light-emitting element 3 and the light-receiving elements 4 and 5 cannot be changed freely, and hence the normal lines 14, 15, and 16 are substantially parallel to each other, and in some cases, the required detection accuracy may not be secured.

To cope with this problem, when the light-receiving sensitivity is decreased, the dynamic range of a signal may be secured by increasing an amplification gain of an electric circuit. However, when the amplification gain of the electric circuit is increased, the time constant is generally increased, and hence it takes a long period of time to converge the output values of the light-receiving elements 4 and 5 on their original values. As a result, the temporal response is degraded, and the required response may not be obtained under a measurement condition in which the test pattern 10 is moved at a higher speed.

Further, the amount of the light entering the light-receiving element 5 that detects the diffused reflection light from the test pattern 10 including the toner image is generally smaller than the amount of the light entering the light-receiving element 4 that detects the regular reflection light from the belt 120.

This is because the diffused reflection light is diffused in all directions so that a proportion of the diffused reflection light entering the light-receiving element 5 through the light-guiding path 23 is significantly small as compared to the entire diffused reflection light, and if a distance between the light-receiving element 5 and the belt 120 is increased, the amount of the light is considerably decreased.

On the other hand, for the regular reflection light, a direction of the reflection is much more limited than that of the diffused reflection light. Therefore, even when the reflectance of the belt 120 is more or less decreased, a large proportion of the light can be received so long as the light-receiving element 4 is arranged at a proper position, and the attenuation of the light due to the distance between the light-receiving element 4 and the belt 120 is also smaller than that of the diffused reflection light.

In this manner, the amount of the receivable light is smaller in the diffused reflection light than in the regular reflection light in the first place. Therefore, the decrease of the light-receiving sensitivity of the light-receiving element 5 to the diffused reflection light is more likely to adversely affect the detection accuracy of the toner detection device 131 than the decrease of the light-receiving sensitivity of the light-receiving element 4 to the regular reflection light.

In this embodiment, as described above, the detection accuracy of the toner detection device 131 is increased while maintaining the angle between the target detection portion D of the outer circumferential surface of the belt 120 and each of the optical axis line 6, the optical axis line 7, and the optical axis line 8.

To this end, in this embodiment, the circuit board 2 is arranged by inclining (predetermined angle inclination) the mounting surface 2a of the circuit board 2 by the predetermined angle θk with respect to the planar surface (ridge line 120a) including the target detection portion D of the outer circumferential surface of the belt 120.

This aspect is described below. As illustrated in FIGS. 3 to 5 and 7, in this embodiment, the light-emitting element 3 and the first and second light-receiving elements 4 and 5 are arranged on the same circuit board 2 (the same circuit board), specifically, on the same planar surface and at predetermined intervals on the same straight line.

As illustrated in FIGS. 4 and 7, normal lines are drawn to the planar surface (ridge line 120a) including the reflection surface (light emitted surface) defined by the outer circumferential surface of the belt 120 respectively from the light-emitting surface 3a of the light-emitting element 3, the light-receiving surface 4a of the first light-receiving element 4, and the light-receiving surface 5a of the second light-receiving element 5. Lengths of the normal lines are then assigned with L1, L2, and L3, respectively.

Among these lengths, the length L3 of the normal line drawn to the planar surface (ridge line 120a) including the reflection surface (light emitted surface) defined by the outer circumferential surface of the belt 120 from the light-receiving surface 5a of the second light-receiving element 5 is set to be the smallest. This setting is performed by arranging the mounting surface 2a of the circuit board 2 with an inclination (predetermined angle inclination) by the predetermined angle θk with respect to the planar surface (ridge line 120a) including the target detection portion D of the outer circumferential surface of the belt 120.

In this embodiment, the length of the normal line drawn to the planar surface (ridge line 120a) including the target detection portion (light emitted surface) D of the outer circumferential surface of the belt 120 from the light-emitting surface 3a of the light-emitting element 3 is set to L1. The length of the normal line drawn to the planar surface (ridge line 120a) including the target detection portion (light emitted surface) D of the outer circumferential surface of the belt 120 from the light-receiving surface 4a of the light-receiving element 4 is set to L2. The length of the normal line drawn to the planar surface (ridge line 120a) including the target detection portion D of the outer circumferential surface of the belt 120 from the light-receiving surface 5a of the light-receiving element 5 is set to L3. The light-emitting element 3 and the first and second light-receiving elements 4 and 5 are then arranged to satisfy the relationship in which L1 is larger than L2 and L2 is larger than L3(L3<L2<L1).

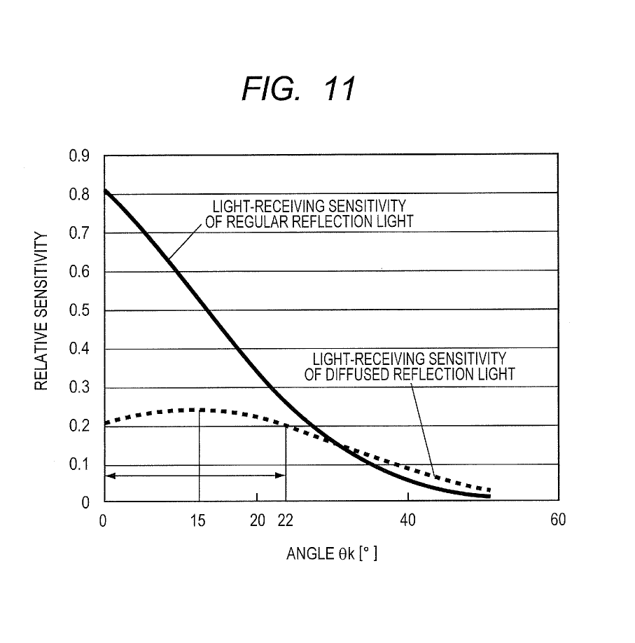

FIG. 11 is a graph showing the light-receiving sensitivity of the light-receiving element 4 to the regular reflection light and the light-receiving sensitivity of the light-receiving element 5 to the diffused reflection light with respect to the inclination angle θk of the mounting surface 2a of the circuit board 2 in this embodiment. In the graph of FIG. 11, a change of the emission intensity of the light-emitting element 3 is added to the sensitivities of the light-receiving elements 4 and 5 as single units due to the inclination of the light-receiving elements 4 and 5.

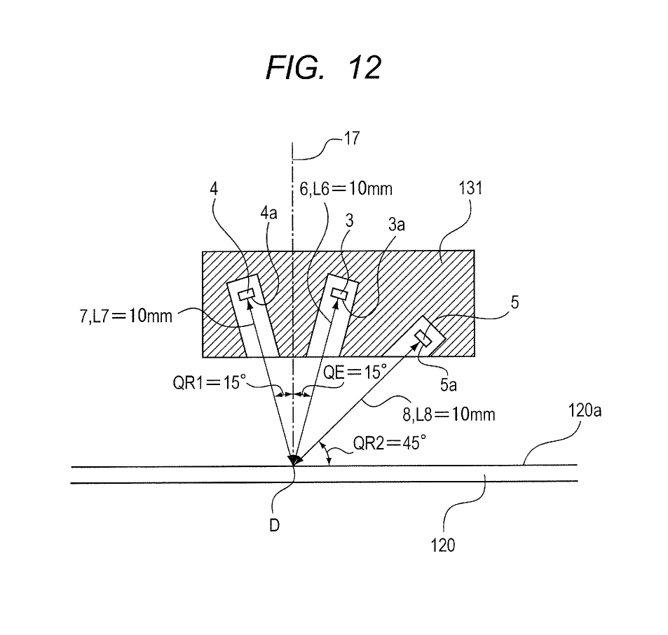

The sensitivity shown in FIG. 11 is based on the light-receiving sensitivity of a configuration illustrated in FIG. 12 that is set to “1” as a reference level.

FIG. 12 is an explanatory cross-sectional view illustrating a configuration of the optical sensor that sets the reference level of the emission light intensity of the light-emitting element 3 and the light-receiving sensitivities of the light-receiving elements 4 and 5 to the regular reflection light and the diffused reflection light. As illustrated in FIG. 12, the distance from the target detection portion D to each of the light-emitting element 3 and the light-receiving elements 4 and 5 is 10 mm (that is, L6=L7=L8=10 mm). In addition, the normal line of the light-emitting surface 3a of the light-emitting element 3 matches the optical axis line 6, the normal line of the light-receiving surface 4a of the light-receiving element 4 matches the optical axis line 7, and the normal line of the light-receiving surface 5a of the light-receiving element 5 matches the optical axis line 8.

The angle θR2 between the optical axis line 8 of the diffused reflection light entering the light-receiving element 5 and the ridge line 120a of the belt 120, which is a diffused reflection light optical axis angle, is set to 45 degrees, and the angle θE between the optical axis line 6 of the light-emitting element 3 and the normal line 17 of the belt 120, which is an emission light optical axis angle of the light-emitting element 3, is set to 15 degrees. The angle θR1 between the optical axis line 7 of the regular reflection light entering the light-receiving element 4 and the normal line 17 of the belt 120, which is a regular reflection light optical axis angle, is set to 15 degrees.

The emission light intensity at the target detection portion D from the light-emitting surface 3a of the light-emitting element 3 in the optical sensor having the configuration illustrated in FIG. 12 is set to “1”. Further, the light-receiving sensitivity of the light-receiving element 4 to the regular reflection light at this time is set to “1”. Moreover, the light-receiving sensitivity of the light-receiving element 5 to the diffused reflection light at this time is set to “1”. The respective reference levels are set with this operation.

As shown in FIG. 11, the light-receiving sensitivity of the light-receiving element 4 to the regular reflection light is decreased as the inclination angle θk of the mounting surface 2a of the circuit board 2 is increased. This is because the emission intensity of the light-emitting element 3 is decreased as the inclination angle θk of the mounting surface 2a of the circuit board 2 is increased so that the light-receiving sensitivity of the light-receiving element is influenced by the decrease of the emission intensity of the light-emitting element 3.

On the other hand, when the inclination angle θk of the mounting surface 2a of the circuit board 2 is increased, the sensitivity of the light-receiving element 5 to the diffused reflection light is gradually increased. In particular, when the inclination angle θk of the mounting surface 2a of the circuit board 2 is 15 degrees, the sensitivity of the light-receiving element 5 to the diffused reflection light reaches the peak, and when the inclination angle θk of the mounting surface 2a of the circuit board 2 exceeds 15 degrees, the sensitivity of the light-receiving element 5 to the diffused reflection light is gradually decreased.

From this point, it is preferred that an angle larger than 0 degree and equal to or smaller than 22 degrees be set as the inclination angle θk of the mounting surface 2a of the circuit board 2 with respect to the planar surface (ridge line 120a) including the target detection portion (light emitted surface) D of the outer circumferential surface (reflection surface) of the belt 120. In this manner, when θk is more than 0 degree and equal to or less than 22 degrees, the light-receiving sensitivity to the diffused reflection light can be increased compared to the case where the mounting surface 2a of the circuit board 2 is not inclined (θk=0 degree).

On the other hand, the light-receiving sensitivity to the regular reflection light is decreased compared to the case where the mounting surface 2a of the circuit board 2 is not inclined (θk=0 degree), but there is no problem in actual usage because a sufficiently large amount of the light is detected compared to the diffused reflection light as described above.

Another embodiment of the first embodiment is described below. The another embodiment of the first embodiment is hereinafter described as “another embodiment of Embodiment 1”.

### Another Embodiment of First Embodiment

### Another Embodiment of Embodiment 1

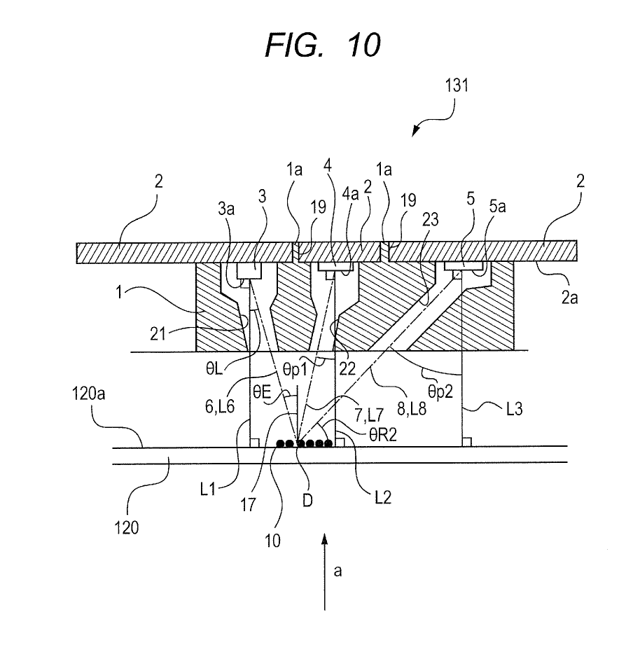

FIG. 10 is a cross-sectional view of a toner detection device 131 according to the another embodiment of Embodiment 1. Components having the same configurations as those of the above-mentioned first embodiment are assigned with the same reference symbols and descriptions thereof are omitted. In the another embodiment of Embodiment 1, the circuit board 2 is arranged in parallel to the ridge line 120a of the outer circumferential surface of the belt 120.

In the another embodiment of Embodiment 1, the angle θE between the optical axis line 6 of the light-emitting element 3 and the normal line 17 of the belt 120, which is the emission light optical axis angle of the light-emitting element 3, is set to 15 degrees, and the angle θR2 between the optical axis line 8 of the diffused reflection light entering the light-receiving element 5 and the ridge line 120a of the belt 120, which is the diffused reflection light optical axis angle, is set to 45 degrees. The inclination angle θk of the mounting surface 2a of the circuit board 2 is 0 degree. The angle θL of the optical axis line 6 of the light exiting from the light-emitting element 3 is 15 degrees, the incident angle θp1 of the regular reflection light entering the light-receiving element 4 is 15 degrees, and the incident angle θp2 of the diffused reflection light entering the light-receiving element 5 is 45 degrees.

### Comparison Between First Embodiment and Another Embodiment of Embodiment 1

The first embodiment illustrated in FIG. 7 and the another embodiment of Embodiment 1 illustrated in FIG. 10 are compared with each other below. By inclining the circuit board 2 to the side on which the light-receiving element 5 for detecting the diffused reflection light is close to the belt 120 as in the first embodiment, the angle θp2 between the optical axis line 8 of the diffused reflection light entering the light-receiving element 5 and the normal line 16 of the light-receiving surface of the light-receiving element 5 can be decreased compared to the another embodiment of Embodiment 1.

With this configuration, the diffused reflection light entering the light-receiving element 5 can be received at an angle providing a higher light-receiving sensitivity so that the light-receiving sensitivity to the diffused reflection light can be increased. Further, the attenuation of the light due to the distance is decreased because the light-receiving element 5 is close to the belt 120, and hence the light-receiving sensitivity of the light-receiving element 5 to the diffused reflection light can be increased. Similarly, the angle θp1 between the optical axis line 7 and the normal line 15 of the light-receiving surface of the light-receiving element 4 can be decreased compared to the another embodiment of Embodiment 1, and hence the light-receiving sensitivity of the light-receiving element 4 itself can be increased.

On the other hand, when the circuit board 2 is inclined to a side on which the light-emitting element 3 separates from the belt 120, the angle θL between the optical axis line 6 of the light exiting from the light-emitting element 3 and the normal line 14 of the light-emitting surface 3a of the light-emitting element 3 is increased, and a distance of the light-emitting element 3 from the belt 120 is increased, which decreases the light intensity.

Regarding an amount of the decrease of the light intensity due to the large distance from the belt 120 to the light-emitting element 3 and an amount of the increase of the sensitivity due to the small distance from the belt 120 to the light-receiving element 5 for detecting the diffused reflection light, an optical path length added on the optical path from the light-emitting element 3 to the light-receiving element 5 is not significantly changed. Therefore, the amount of the change due to the distance of the light-emitting element 3 to the belt 120 is small.

On the other hand, regarding the angle θL of the optical axis line 6 of the light-emitting element 3 and the angle θp2 of the optical axis line 8 of the light-receiving element 5, the emission intensity of the light-emitting element 3 is decreased on an emission side on which the rate of change is small with respect to the angle θL of the optical axis line 6. Therefore, the increase of the light-receiving sensitivity due to the change of the angle θp2 of the optical axis line 8 of the light-receiving element 5 on the light-receiving side has a higher increase rate so that the sensitivity is increased as a total.

This sensitivity increasing effect causes the separation distance L3 between the belt 120 and the light-receiving element 5 that receives the diffused reflection light on the circuit board 2 to be smaller than the separation distance L1 between the belt 120 and the light-emitting element 3 on the circuit board 2. This is achieved by inclining the circuit board 2 with respect to the ridge line 120a of the belt 120.

It is most preferred that the inclination angle θk between an extension line 31 of the planar surface (mounting surface 2a) of the circuit board 2 and an extension line 32 of the ridge line 120a of the belt 120 be an angle substantially equivalent to the angle θE between the optical axis line 6 of the light-emitting element 3 and the normal line 17 of the belt 120 in terms of the sensitivity. The sensitivity increasing effect cannot be obtained when the inclination angle θk is equal to or larger than an angle that is two times the angle θE, and hence it is preferred that the inclination angle θk be smaller than the angle that is two times the angle θE.

In the first embodiment, the angle θE between the optical axis line 6 of the light-emitting element 3 and the normal line 17 of the belt 120, which is the emission light optical axis angle, is set to 15 degrees, and the angle θR2 between the optical axis line 8 of the diffused reflection light entering the light-receiving element 5 and the ridge line 120a of the belt 120, which is the diffused reflection light optical axis angle, is set to 45 degrees. When the inclination angle θk of the circuit board 2 is set to 15 degrees, the angle θL of the optical axis line 6 from the light-emitting element 3 is 30 degrees, the incident angle θp1 of the regular reflection light entering the light-receiving element 4 is 0 degree, and the incident angle θp2 of the diffused reflection light entering the light-receiving element 5 is 30 degrees.

It is preferred that the angle θR1 between the optical axis line 7 of the regular reflection light and the normal line 17 of the belt 120 be substantially the same as the angle θE between the optical axis line 6 of the light-emitting element 3 and the normal line 17 of the belt 120. For this reason, when the angle θE, the angle θR2 between the optical axis line 8 of the light-receiving element 5 and the ridge line 120a of the belt 120, and the inclination angle θk between the extension line 31 of the planar surface of the circuit board 2 and the extension line 32 of the ridge line 120a of the belt 120 are determined, and then the separation distance L1 or L2 from the belt 120 to the light-emitting element 3 or the light-receiving element 4 for detecting the regular reflection light is determined, the other angles θR1, θL, θp1, and θp2 and the separation distance L3 from the belt 120 to the light-receiving element 5 for detecting the diffused reflection light are automatically determined.

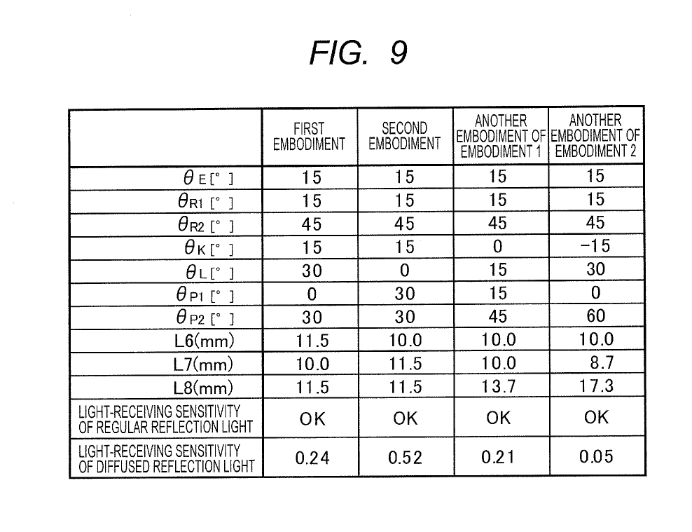

FIG. 9 is a table showing characteristics of the toner detection device 131 according to each of the first embodiment, each of the another embodiment of Embodiment 1, a second embodiment of the present invention that is described later, and another embodiment of Embodiment 2 that is described later. L7 shown in FIG. 9 is the distance on the optical axis line 7 to the belt 120 from the light-receiving element 4 for detecting the regular reflection light illustrated in FIG. 7, which is set to 10 mm in the first embodiment. The circuit board 2 is inclined at inclination angle θk=15 degrees while maintaining the separation distance L2 to the belt 120 from the light-receiving element 4 for detecting the regular reflection light, which is arranged in the center in the order of arranging the three optical elements on the circuit board 2.

L6 shown in FIG. 9 is the distance on the optical axis line 6 from the light-emitting element 3 to the belt 120 illustrated in FIG. 7, which is set to 11.5 mm in the first embodiment. L8 shown in FIG. 9 is the distance on the optical axis line 8 to the belt 120 from the light-receiving element 5 for detecting the diffused reflection light illustrated in FIG. 7, which is set to 11.5 mm in the first embodiment. The sensitivity to the light intensity of the regular reflection light entering the light-receiving element 4 is sufficiently high without causing any problem.

The sensitivity to the light intensity of the diffused reflection light entering the light-receiving element 5 is 0.24 times the reference level that is the sensitivity of the optical sensor illustrated in FIG. 12 described above.

FIG. 9 is the table showing the characteristics of the toner detection device 131 according to the another embodiment of Embodiment 1. L7 shown in FIG. 9 is the distance on the optical axis line 7 to the belt 120 from the light-receiving element 4 for detecting the regular reflection light illustrated in FIG. 10, which is set to 10 mm in the same manner as in the first embodiment described above for comparison.

L6 shown in FIG. 9 is the distance on the optical axis line 6 from the light-emitting element 3 to the belt 120 illustrated in FIG. 10, which is set to 10.0 mm in the another embodiment of Embodiment 1. L8 shown in FIG. 9 is the distance on the optical axis line 8 to the belt 120 from the light-receiving element 5 for detecting the diffused reflection light illustrated in FIG. 10, which is set to 13.7 mm in the another embodiment of Embodiment 1.

In the another embodiment of Embodiment 1, the sensitivity to the light intensity of the regular reflection light entering the light-receiving element 4 is sufficiently high without causing any problem. The sensitivity to the light intensity of the diffused reflection light entering the light-receiving element 5 is 0.21 times the reference level.

From the above, as a result of the comparison between the first embodiment and the another embodiment of Embodiment 1, the sensitivity of the light-receiving element 5 according to the first embodiment to the diffused reflection light is higher than that of the another embodiment of Embodiment 1 by about 13%. As described above, the sensitivity to the light intensity of the diffused reflection light entering the light-receiving element 5 according to the first embodiment is about 0.24 times (precisely 0.23868 . . . times) the reference level. The sensitivity to the light intensity of the diffused reflection light entering the light-receiving element 5 according to the another embodiment of Embodiment 1 is about 0.21 times (precisely 0.21053 . . . times) the reference level. Therefore, an increase of about 13% is obtained from (0.23868)/(0.21053)=1.1337 . . . (=about 113%).

As described above, in those embodiments (first embodiment and another embodiment of Embodiment 1), the wall portion 1a of the housing 1 is inserted into the hole 19 formed in the circuit board 2. With this configuration, the light emitted from the light-emitting element 3 is prevented from arriving at the light-receiving elements 4 and 5 through the inside of the housing 1 or the inside of the circuit board 2 without being emitted to the outer circumferential surface of the belt 120 so that the light becomes the disturbance light (stray light), thus improving the light shielding effect. However, as the configuration to improve the light shielding effect, all the light-emitting element 3 and the light-receiving elements 4 and 5 are not necessarily to be mounted on the circuit board 2 so long as the wall portion 1a of the housing 1 is inserted into the hole 19 formed in the circuit board 2. That is, it suffices that at least the light-emitting element 3 and one of the light-receiving elements 4 and 5 are provided on the mounting surface of the circuit board 2 and the wall portion 1a engaged with the hole 19 is provided between the light-emitting element and the light-receiving element.

In addition to the above description, in the first embodiment, by inclining the circuit board 2, the incident angle θp2 of the diffused reflection light entering the light-receiving element 5 is decreased so that the incident angle is improved, leading to an increase of the light-receiving sensitivity to the diffused reflection light that is difficult to secure the light intensity compared to the regular reflection light. This enables light-receiving output of the diffused reflection light to be increased, resulting in an increase of the sensitivity of the entire optical sensor.

### Second Embodiment

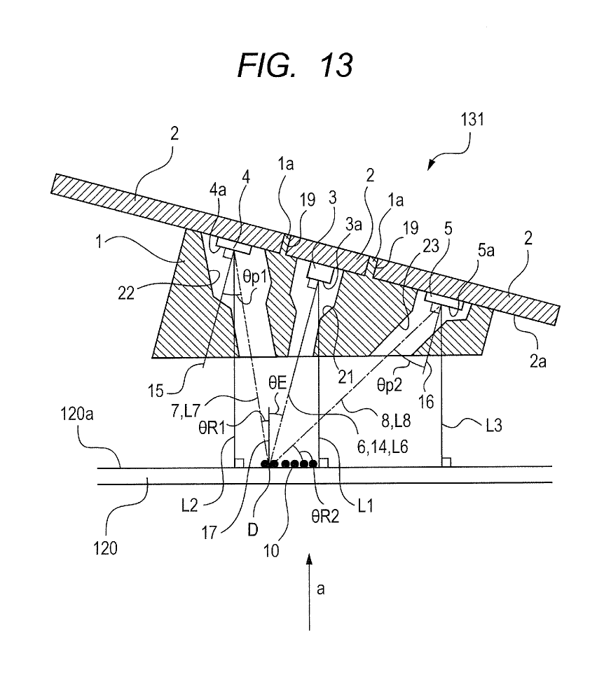

A configuration of an image forming apparatus including a toner detection device according to the second embodiment of the present invention is described with reference to FIGS. 13 to 15. Components having the same configurations as those of the first embodiment are assigned with the same reference symbols and descriptions thereof are omitted.

FIG. 13 is a cross-sectional view of a toner detection device 131 according to the second embodiment. In the second embodiment, the arrangement of the light-emitting element 3 and the light-receiving elements 4 and 5 that are the optical elements arranged on the circuit board 2 on the straight line is different from that of the first embodiment. In the second embodiment, the optical element on the leftmost side of FIG. 13 is the light-receiving element 4 for detecting the regular reflection light, the optical element on the rightmost side is the light-receiving element 5 for detecting the diffused reflection light, and the light-emitting element 3 is arranged between the light-receiving elements 4 and 5. As illustrated in FIG. 13, the wall portion 1a and the slit hole 19 are provided between the light-emitting element 3 and the light-receiving element 4 and between the light-emitting element 3 and the light-receiving element 5. Therefore, through engagement of the wall portion (light shielding portion) 1a with the slit hole 19, more secure shielding is obtained (the light is shielded from traveling) between the light-guiding path 21 and the light-guiding path 22 and between the light-guiding path 21 and the light-guiding path 23 in the housing 1.

In the second embodiment, the length of the normal line drawn to the planar surface (ridge line 120a) including the reflection surface (light emitted surface) defined by the outer circumferential surface of the belt 120 from the light-emitting surface 3a of the light-emitting element 3 is set to L1. The length of the normal line drawn to the planar surface (ridge line 120a) including the reflection surface (light emitted surface) defined by the outer circumferential surface of the belt 120 from the light-receiving surface 4a of the first light-receiving element 4 is set to L2. The length of the normal line drawn to the planar surface (ridge line 120a) including the reflection surface (light emitted surface) defined by the outer circumferential surface of the belt 120 from the light-receiving surface 5a of the second light-receiving element 5 is set to L3. The light-emitting element 3 and the first and second light-receiving elements 4 and 5 are then arranged to satisfy the relationship in which L2 is larger than L1 and L1 is larger than L3 (L3<L1<L2), as an example.

In the second embodiment, the angle θE between the optical axis line 6 of the light-emitting element 3 and the normal line 17 of the belt 120, which is the emission light optical axis angle of the light-emitting element 3, is set to 15 degrees, and the angle θR2 between the optical axis line 8 of the diffused reflection light entering the light-receiving element 5 and the ridge line 120a of the belt 120, which is the diffused reflection light optical axis angle, is set to 45 degrees. The inclination angle θk between the planar surface (mounting surface 2a) of the circuit board 2 and the ridge line 120a of the belt 120 is 15 degrees.

The angle θL between the optical axis line 6 of the emission light exiting from the light-emitting element 3 and the normal line 14 of the light-emitting surface 3a of the light-emitting element 3 is 0 degree. The angle θp1 between the optical axis line 7 of the regular reflection light entering the light-receiving element 4 and the normal line 15 of the light-receiving surface 4a of the light-receiving element 4, which is the incident angle of the regular reflection light on the light-receiving element 4, is 30 degrees. The angle θp2 between the optical axis line 8 of the diffused reflection light entering the light-receiving element 5 and the normal line 16 of the light-receiving surface 5a of the light-receiving element 5, which is the incident angle of the diffused reflection light on the light-receiving element 5, is 30 degrees.

FIG. 9 is the table showing the characteristics of the toner detection device 131 according to the second embodiment. L6 shown in FIG. 9 is the distance on the optical axis line 6 from the light-emitting element 3 to the belt 120 illustrated in FIG. 13, which is set to 10 mm in the same manner as in the another embodiment of Embodiment 1 described above for comparison.

L7 shown in FIG. 9 is the distance on the optical axis line 7 to the belt 120 from the light-receiving element 4 for detecting the regular reflection light illustrated in FIG. 13, which is set to 11.5 mm in the second embodiment. L8 shown in FIG. 9 is the distance on the optical axis line 8 to the belt 120 from the light-receiving element 5 for detecting the diffused reflection light illustrated in FIG. 13, which is set to 11.5 mm in the second embodiment.

In the second embodiment, the sensitivity to the light intensity of the regular reflection light entering the light-receiving element 4 is sufficiently high without causing any problem. The sensitivity to the light intensity of the diffused reflection light entering the light-receiving element 5 is 0.52 times the reference level.

In the second embodiment as well, in the same manner as in the first embodiment, the inclination angle θk between the planar surface (mounting surface 2a) of the circuit board 2 and the ridge line 120a of the belt 120 is set to 15 degrees. With this arrangement, the angle θL between the optical axis line 6 of the emission light exiting from the light-emitting element 3 and the normal line 14 of the light-emitting surface 3a becomes 0 degree so that the toner detection device 131 can be used at the peak of the emission light intensity. The increase of the light intensity on the exit side contributes to the increase of the sensitivity compared to the another embodiment of Embodiment 1.

The sensitivity increasing effect according to the second embodiment is achieved by inclining the circuit board 2 in a direction in which the angle θL between the optical axis line 6 connecting the light-emitting element 3 and the target detection portion D on the belt 120 for the toner detection device 131 and the normal line 14 of the light-emitting surface 3a of the light-emitting element 3 is decreased.

In addition to the above-mentioned effect, the angle θp2 between the optical axis line 8 of the diffused reflection light entering the light-receiving element 5 and the normal line 16 of the light-receiving surface 5a of the light-receiving element 5, which is the incident angle of the diffused reflection light on the light-receiving element 5, can be reduced to 30 degrees. Therefore, by combination with the increase of the light-receiving sensitivity of the light-receiving element 5 to the diffused reflection light, the sensitivity of the entire toner detection device 131 is considerably increased.

The inclination angle θk between the planar surface (mounting surface 2a) of the circuit board 2 and the ridge line 120a of the belt 120 is set so that the light-receiving element 5 for detecting the diffused reflection light is close to the belt 120. With this configuration, when the angle θR2 between the optical axis line 8 of the diffused reflection light entering the light-receiving element 5 and the ridge line 120a of the belt 120 is the same, the angle θp2 between the optical axis line 8 of the diffused reflection light entering the light-receiving element 5 and the normal line 16 of the light-receiving surface 5a of the light-receiving element 5 can be reduced. This enables the light to be received at an angle that provides a higher sensitivity of the light-receiving element 5 to the diffused reflection light so that the light-receiving sensitivity to the diffused reflection light can be increased.

In addition, by arranging the light-receiving element 5 close to the belt 120, the attenuation of the light due to the separation distance between the light-receiving element 5 and the belt 120 is reduced, which enables the light-receiving sensitivity of the light-receiving element 5 to the diffused reflection light to be increased. Further, the angle θL between the optical axis line 6 of the emission light exiting from the light-emitting element 3 and the normal line 14 of the light-emitting surface 3a of the light-emitting element 3 is decreased so that the light of a portion where the emission intensity of the light-emitting element 3 is high is output from the light-guiding path 21 of the housing 1, resulting in an increase of the emission light intensity. These two effects are combined and the sensitivity of the toner detection device 131 is increased as a total.

This effect can be achieved with the following configuration. That is, the light-emitting element 3 and the light-receiving elements 4 and 5, which are the optical elements to be arranged on the circuit board 2 on the straight line, are arranged in the order of, as illustrated in FIG. 13, the light-receiving element 5 for measuring the diffused reflection light, the light-emitting element 3, and the light-receiving element 4 for measuring the regular reflection light in terms of the distance from the belt 120. Then, the circuit board 2 is inclined in the direction in which the light-receiving element 5 for measuring the diffused reflection light is close to the belt 120, or in the direction in which the angle θL between the normal line 14 of the light-emitting surface 3a of the light-emitting element 3 and the optical axis line 6 connecting the light-emitting element 3 and the target detection portion D of the toner detection device 131 is decreased.

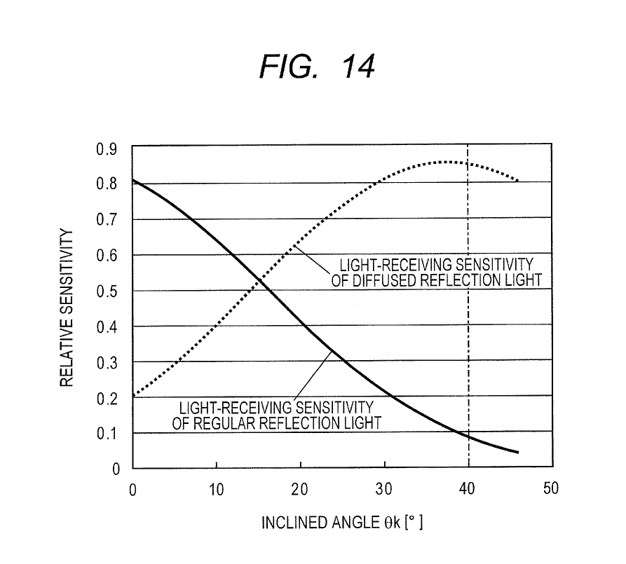

FIG. 14 is a graph showing changes of the light-receiving sensitivity of the light-receiving element 4 to the regular reflection light and the light-receiving sensitivity of the light-receiving element 5 to the diffused reflection light when the inclination angle θk between the planar surface (mounting surface 2a) of the circuit board 2 and the ridge line 120a of the belt 120 is changed in the following configuration. That is, the light-emitting element 3 and the light-receiving elements 4 and 5, which are the optical elements to be arranged on the circuit board 2 on the straight line, are arranged in the order of the second embodiment illustrated in FIG. 13. The angle θE between the optical axis line 6 of the light-emitting element 3 and the normal line 17 of the belt 120 is set to 15 degrees, the angle θR1 between the optical axis line 7 of the regular reflection light entering the light-receiving element 4 and the normal line 17 of the belt 120 is set to 15 degrees, and the angle θR2 between the optical axis line 8 of the diffused reflection light entering the light-receiving element 5 and the ridge line 120a of the belt 120 is set to 45 degrees.

As shown in FIG. 14, as the inclination angle θk between the planar surface (mounting surface 2a) of the circuit board 2 and the ridge line 120a of the belt 120 is increased, the sensitivity of the light-receiving element 5 to the diffused reflection light is increased, and the sensitivity reaches the peak at the inclination angle θk of about 40 degrees. The reason why the peak of the sensitivity is not at the angle of 45 degrees is because the emission intensity of the light-emitting element 3 is decreased when the inclination angle θk is 15 degrees or more. When the inclination angle θk exceeds 40 degrees, the sensitivity of the light-receiving element 5 to the diffused reflection light is gradually decreased.

On the other hand, the light-receiving sensitivity of the light-receiving element 4 to the regular reflection light is decreased as the inclination angle θk of the circuit board 2 is increased. This is because the inclination of the light-emitting surface 3a of the light-emitting element 3 with respect to the optical axis line 6 is increased so that the emission intensity is decreased, and the inclination of the light-receiving surface 4a of the light-receiving element 4 with respect to the optical axis line 7 is increased so that the sensitivity is decreased. From these aspects, a detailed study by the inventors of the present invention reveals that the regular reflection light intensity is detected with high accuracy up to the inclination angle θk of about 40 degrees and, when the inclination angle θk exceeds 40 degrees, the light-receiving sensitivity of the light-receiving element 4 is considerably decreased.

Considering the decrease of the sensitivity to the regular reflection light entering the light-receiving element 4, it is preferred that an angle larger than 0 degree and equal to or smaller than 40 degrees be set as the inclination angle θk of the mounting surface 2a of the circuit board 2 with respect to the planar surface (ridge line 120a) including the target detection portion D of the outer circumferential surface (reflection surface) of the belt 120. That is, it is preferred that the inclination angle θk is more than 0 and equal to or less than 40 degrees.

In the second embodiment, as illustrated in FIG. 13, the light-receiving output of the diffused reflection light is increased by improving the incident angle due to the decrease of the incident angle θp2 of the diffused reflection light on the light-receiving element 5. Therefore, the light-receiving sensitivity to the diffused reflection light for which it is difficult to secure the light intensity compared to the regular reflection light is increased, and as a result, the sensitivity of the entire optical sensor is considerably increased. The other configurations are the same as those of the first embodiment so that the same effect can be obtained.

### Another Embodiment of Second Embodiment

### Another Embodiment of Embodiment 2

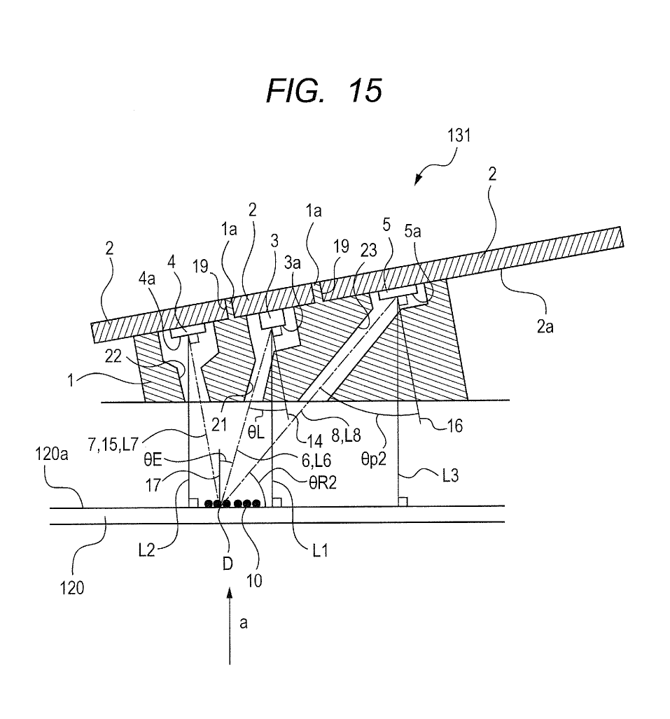

FIG. 15 is a cross-sectional view of a toner detection device 131 according to the another embodiment of Embodiment 2. Components having the same configurations as those of the first or second embodiment are assigned with the same reference symbols and descriptions thereof are omitted. In the another embodiment of Embodiment 2, the circuit board 2 is inclined to a side on which the light-receiving element 5 on the diffused reflection light side is separated from the belt 120 as an example.

In the another embodiment of Embodiment 2, the angle θE between the optical axis line 6 of the light-emitting element 3 and the normal line 17 of the belt 120 is set to 15 degrees, and the angle θR2 between the optical axis line 8 of the diffused reflection light entering the light-receiving element 5 and the ridge line 120a of the belt 120 is set to 45 degrees. The inclination angle θk between the planar surface (mounting surface 2a) of the circuit board 2 and the ridge line 120a of the belt 120 is −15 degrees.

The angle θL between the optical axis line 6 of the emission light exiting from the light-emitting element 3 and the normal line 14 of the light-emitting surface 3a is 30 degrees. The angle θp1 between the optical axis line 7 of the regular reflection light entering the light-receiving element 4 and the normal line 15 of the light-receiving surface 4a of the light-receiving element 4 is 0 degree. The angle θp2 between the optical axis line 8 of the diffused reflection light entering the light-receiving element 5 and the normal line 16 of the light-receiving surface 5a of the light-receiving element 5 is 60 degrees.

FIG. 9 is the table showing the characteristics of the toner detection device 131 according to the another embodiment of Embodiment 2. L6 shown in FIG. 9 is the distance on the optical axis line 6 from the light-emitting element 3 to the belt 120 illustrated in FIG. 15, which is set to 10 mm in the same manner as in the second embodiment and the another embodiment of Embodiment 1 for comparison.

L7 shown in FIG. 9 is the distance on the optical axis line 7 to the belt 120 from the light-receiving element 4 for detecting the regular reflection light illustrated in FIG. 15, which is set to 8.7 mm in the another embodiment of Embodiment 2.

L8 shown in FIG. 9 is the distance on the optical axis line 8 to the belt 120 from the light-receiving element 5 for detecting the diffused reflection light illustrated in FIG. 15, which is set to 17.3 mm in the another embodiment of Embodiment 2.

In the another embodiment of Embodiment 2, the sensitivity to the light intensity of the regular reflection light entering the light-receiving element 4 is sufficiently high without causing any problem. The sensitivity to the light intensity of the diffused reflection light entering the light-receiving element 5 is 0.05 times the reference level.

In the another embodiment of Embodiment 2, the angle θp2 between the optical axis line 8 of the diffused reflection light entering the light-receiving element 5 and the normal line 16 of the light-receiving surface 5a of the light-receiving element 5 is as large as 60 degrees. Therefore, the light-receiving sensitivity of the light-receiving element 5 to the diffused reflection light is decreased to about a quarter of the light-receiving sensitivity at the peak and the separation distance between the light-receiving element 5 and the belt 120 is increased, and hence the attenuation of the light intensity is significant.

As described above, according to those embodiments (second embodiment and another embodiment of Embodiment 2), in the same manner as in the first embodiment, the light shielding effect can be improved by the configuration in which the wall portion 1a of the housing 1 is inserted into the hole 19 provided in the circuit board 2. In addition to this aspect, in the second embodiment, by inclining the circuit board 2, the incident angle θp2 of the diffused reflection light on the light-receiving element 5 is decreased so that the incident angle is improved, thus increasing the light-receiving output of the diffused reflection light. Therefore, the light-receiving sensitivity to the diffused reflection light for which it is difficult to secure the light intensity compared to the regular reflection light is increased, and as a result, the sensitivity of the entire optical sensor is considerably increased.

### Third Embodiment

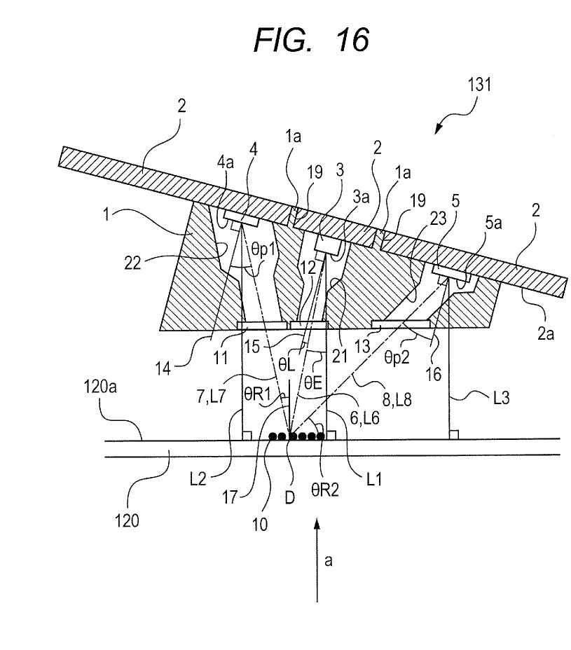

A configuration of an image forming apparatus including a toner detection device according to a third embodiment of the present invention is described with reference to FIG. 16. Components having the same configurations as those of the above-mentioned embodiments are assigned with the same reference symbols and descriptions thereof are omitted.

In the above-mentioned embodiments, the toner detection device 131 of the type that separates the regular reflection light and the diffused reflection light at the positions of the light-receiving elements 4 and 5 without using a polarization plate in the toner detection device 131 is described as an example. The effect of the present invention can be produced regardless of the presence of the polarization plate.

For example, as illustrated in FIG. 16, the present invention can also be suitably applied to a configuration in which polarization plates 12, 11, and 13 are respectively provided on entrances of the light-guiding paths 21, 22, and 23 of the light-emitting element 3 and the light-receiving elements 4 and 5 that are optical elements arranged on the circuit board 2 on a straight line. Reference symbol 12 is the polarization plate arranged on a side of the light-emitting element 3. Reference symbol 11 is the polarization plate arranged on a side of the light-receiving element 4 for detecting the regular reflection light, and the direction of the polarization plate 11 is adjusted to a direction in which polarized light passes in the same direction as the polarization plate 12.

The polarization plate 13 as a filter on a side of the light-receiving element 5 for detecting the diffused reflection light is directed to a direction in which polarized light of a direction that is different by 90 degrees from those of the polarization plates 11 and 12 passes through the polarization plate 13. The other configurations are the same as those of the respective embodiments so that the same effect can be obtained.

### Fourth Embodiment

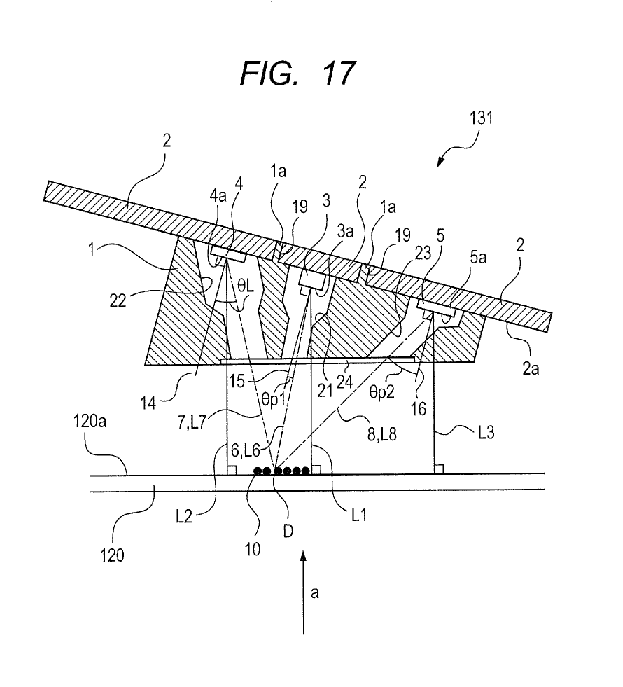

A configuration of an image forming apparatus including a toner detection device according to a fourth embodiment of the present invention is described with reference to FIG. 17. Components having the same configurations as those of the respective embodiments are assigned with the same reference symbols and descriptions thereof are omitted.

In addition to the toner detection device 131 according to each of the embodiments, as illustrated in FIG. 17, a protection cover 24 is provided on a surface facing the belt 120 on a side of the entrances of the light-guiding paths 21, 22, and 23 of the light-emitting element 3 and the light-receiving elements 4 and 5 that are optical elements arranged on the circuit board 2 on a straight line. By providing the protection cover 24, the inside of the sensor can be prevented from being contaminated by toner scattered from the belt 120. The other configurations are the same as those of the respective embodiments so that the same effect can be obtained.

### Fifth Embodiment

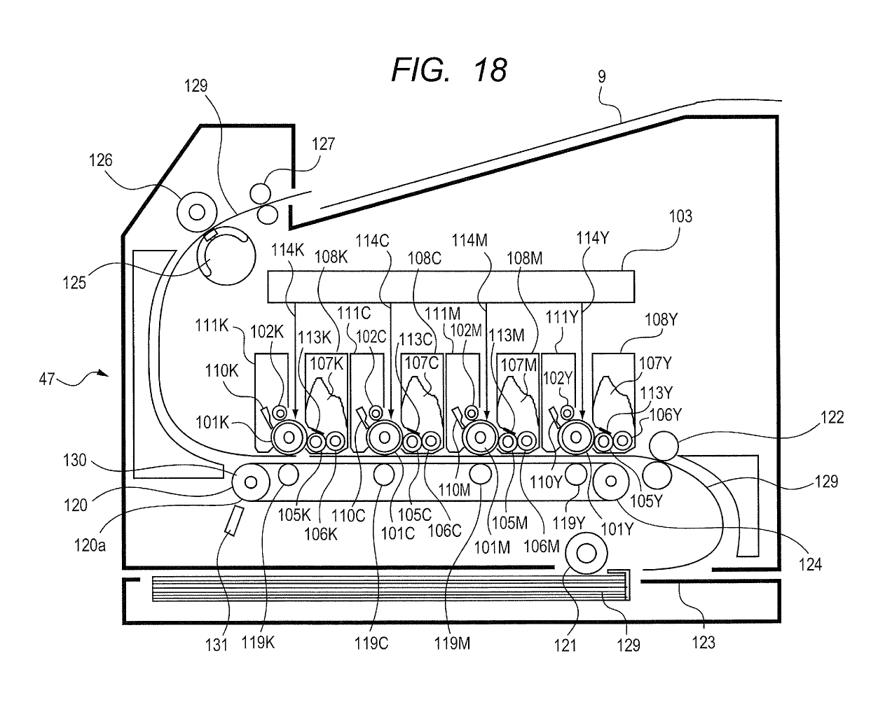

Another configuration of the image forming apparatus including the toner detection device according to the present invention is described below with reference to FIG. 18.

In each of the embodiments, the object to be measured is an intermediate transfer belt of the image forming apparatus 47 configured so that a toner image is primarily transferred from the photosensitive drum 101 onto the belt 120 as the intermediate transfer belt and then secondarily transferred from the belt 120 onto the sheet 129. Then, the toner density of the test pattern 10 on the belt 120 is detected by the toner detection device 131 as the optical sensor, in order to perform registration control for increasing the image position accuracy at the time of forming an image.

In this embodiment, as illustrated in FIG. 18, the belt 120 that is an endless belt for attracting and conveying the sheet 129 is used as the object to be measured. The registration control for increasing the image position accuracy at the time of forming an image is then performed between the toner image formed on the surface of each of the photosensitive drums 101 and the sheet 129 that is attracted and conveyed by the belt 120. To this end, a mark (not shown) formed on the belt 120 that is the object to be measured is detected, and accordingly the position and speed of the belt 120 can be detected.

As illustrated in FIG. 18, the image forming apparatus 47 according to this embodiment is an electrophotographic image forming apparatus 47 that forms a multicolor image. In an image forming unit, an electrostatic latent image is formed by an optical writing on the photosensitive drum 101 that is an image bearing member. The electrostatic latent image is developed into a toner image by using toner, and then the developed toner image is transferred and fixed onto the sheet 129 that is a recording medium.

In general, color toners including a yellow (Y) toner, a magenta (M) toner, and a cyan (C) toner, which are subtractive three primary colors, are used to reproduce a color image on the sheet 129. Toners of a total of four colors further including a black (K) toner used to print a character or a black portion of the image (printing and image formation) are superimposed, thus performing formation of a full color image.

The sheet cassette 123 is installed in the lower portion of the body of the image forming apparatus 47 in a removable manner. When receiving a print command from the host computer 40, the DC controller 42 illustrated in FIG. 2 drives the feed roller 121 to rotate at a predetermined timing so that the sheet 129 in the sheet cassette 123 is fed one by one. The sheet 129 fed by the feed roller 121 is conveyed to the pair of registration rollers 122, and the leading edge of the sheet 129 is bumped and stopped at the nip portion of the pair of registration rollers 122. When the preparation for forming an image is completed and the image formation is started, the sheet 129 is fed to the image forming unit facing the photosensitive drum 101 by the pair of registration rollers 122 at a predetermined timing.

The pair of registration rollers 122 has a function of adjusting a timing for feeding the sheet 129 and adjusting a leading edge position of the sheet 129 so that the leading edge of the sheet 129 becomes perpendicular to a conveying direction. The first image forming station that is the yellow image forming unit is arranged from the right side of FIG. 18. The second image forming station that is the magenta image forming unit having the same configuration as that of the yellow image forming unit is arranged on a downstream side of the sheet conveying direction. Further, the third image forming station that is the cyan image forming unit and the fourth image forming station that is the black image forming unit are arranged so that the four image forming stations are arranged in this order.

The method of forming the toner image of each color is not particularly limited, and for example, the toner image may be formed by a known developing method such as the two-component developing method and the nonmagnetic one-component developing method. In the following, the image forming apparatus 47 that employs the nonmagnetic one-component contact developing method is described as an example.

In the first image forming station that is the yellow image forming unit, the surface of the photosensitive drum 101Y is uniformly charged by the charging roller 102Y that receives the power from the high voltage power supply 44. An electrostatic latent image is then formed on the surface of the photosensitive drum 101Y by the exposure light beam 114Y from the exposure device 103.

The developing roller 105Y is brought into contact with the electrostatic latent image formed on the surface of the photosensitive drum 101Y, and the electrostatic latent image is developed with the toner, to thereby obtain a toner image. A feeding and removing roller 106Y for feeding the toner to or removing the toner from the surface of the developing roller 105Y is brought into contact with the developing roller 105Y with a circumferential speed difference with respect to the developing roller 105Y, which also takes a role of charging the toner on the developing roller 105Y.

A toner layer thickness of the toner on the developing roller 105Y is regulated by the regulating blade 113Y for regulating the toner thickness, and the toner is subjected to triboelectric charging by sliding friction so that the toner suitable for developing is supplied to the photosensitive drum 101Y. The toner image is transferred by the transfer roller 119Y onto the sheet 129 conveyed by the belt 120 that is the object to be measured.

The image forming unit of each color has the same configuration and the same operation except that the color of the toner image to be formed is different. Therefore, in the following description, unless there is a need for particularly distinguishing the image forming units from each other, the suffixes of Y, M, C, and K indicating that the component belongs to the image forming unit of the corresponding color are omitted.

The belt 120 that is an electrostatic transfer belt (ETB) stretched around a driving roller 130 and the tension roller 124 is arranged between the photosensitive drum 101 and the transfer roller 119. The belt 120 is then rotated by the driving roller 130, and attracts the sheet 129 in an electrostatic manner and conveys the sheet 129 to the image forming station of each color.

The tension roller 124 is rotated following the movement of the belt 120 in a state of applying a pressure in a direction in which the belt 120 is stretched so that the belt 120 does not go slack. A shift of the toner image between the colors is reduced by increasing the transfer position accuracy of the toner image from the photosensitive drum 101 onto the sheet 129 by conveying the sheet 129 with the belt 120.

A cleaning blade 110 for collecting and cleaning the transfer residual toner remaining on the photosensitive drum 101 without being transferred is brought into contact with the surface of the photosensitive drum 101, and the transfer residual toner collected by the cleaning blade 110 is contained in a waste toner container 111.

The sheet 129 is separated from the photosensitive drum 101, and then conveyed to the next image forming station. The toner images of magenta, cyan, and black are sequentially transferred onto the toner image of yellow by the same image forming operation as that for yellow, and then the sheet 129 is conveyed to the fixing nip portion of the pressure roller 126 and the heating roller 125. The toner images formed on the sheet 129 are heated and pressurized at the fixing nip portion so that the toner is melted, and hence the toner tightly adheres to the sheet 129 to form a permanent image. The sheet 129 with the toner image fixed is discharged outside the image forming apparatus 47 by a discharge roller 127. The other configurations are the same as those of each of the respective embodiments so that the same effect can be obtained.

In addition, a circulatory moving member such as the photosensitive drum 101 can be used as the object to be measured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-028288, filed Feb. 13, 2012, and Japanese Patent Application No. 2013-015922, filed Jan. 30, 2013, which are hereby incorporated by reference herein in their entirety.

What is claimed is:

1. An optical sensor, comprising:
a light-emitting element configured to emit light to a light emitted surface;
a light-receiving element configured to receive reflection light from the light emitted surface, the reflection light receiving light emitted from the light-emitting element and reflected at the light emitted surface;
a circuit board including a mounting surface on which the light-emitting element and the light-receiving element are mounted; and
a housing fixed to the circuit board,
wherein the reflection light enters the light-receiving element from the light emitted surface without passing through a lens,
wherein optical axes of the light-emitting element and the light-receiving element are perpendicular to the mounting surface,
wherein the housing includes a light shielding portion provided between the light-emitting element and the light-receiving element; and
wherein the light shielding portion is engaged with a hole formed in the circuit board at a position between the light-emitting element and the light-receiving element.

2. An optical sensor according to claim 1, wherein the housing further comprises:
a first light-guiding path configured to guide the light generated in the light-emitting element to the light emitted surface; and
a second light-guiding path configured to guide the reflection light from the light emitted surface to the light-receiving element,
wherein the light shielding portion is configured to shield a portion between the first light-guiding path and the second light-guiding path.

3. An optical sensor according to claim 1, further comprising a polarization plate configured to allow the reflection light to pass therethrough, the polarization plate being provided between the light emitted surface and the light-receiving element.

4. An optical sensor according to claim 1, further comprising a protection cover configured to allow the reflection light to pass therethrough, the protection cover being provided between the light emitted surface and the light-receiving element.

5. An image forming apparatus comprising:
an optical sensor according to claim 1; and
a light emitted surface,
wherein the optical sensor is configured to detect a toner on the light emitted surface
wherein at least a density of the toner on the light emitted surface or a timing at which the toner passes along the light emitted surface is detected based on an output from the optical sensor.

6. An optical sensor, comprising:
a light-emitting element configured to emit light to a light emitted surface;
a first light-receiving element and a second light-receiving element configured to receive reflection light from the light emitted surface, the reflection light receiving light emitted from the light-emitting element and reflected at the light emitted surface;
a circuit board including a mounting surface on which the light-emitting element, the first light-receiving element, and the second light-receiving element are mounted; and
a housing fixed to the circuit board,
wherein the reflection light enters the first light-receiving element and the second light-receiving element from the light emitted surface without passing through a lens;
wherein optical axes of the light-emitting element, the first light-receiving element, and the second light-receiving element are perpendicular to the mounting surface; and
wherein the housing includes light shielding portions provided between the light-emitting element and the first light-receiving element and between the first light-receiving element and the second light-receiving element.

7. An optical sensor according to claim 6, wherein the light shielding portions are respectively engaged with a hole formed in the circuit board at a position between the light-emitting element and the first light-receiving element and a hole formed in the circuit board at a position between the first light-receiving element and the second light-receiving element.

8. An optical sensor according to claim 6,
wherein the first light-receiving element is configured to receive regular reflection light of the reflection light; and
wherein the second light-receiving element is configured to receive diffused reflection light of the reflection light.

9. An image forming apparatus comprising:
an optical sensor according to claim 6; and
a light emitted surface,
wherein the optical sensor is configured to detect a toner on the light emitted surface
wherein at least a density of the toner on the light emitted surface or a timing at which the toner passes along the light emitted surface is detected based on an output from the optical sensor.

10. An optical sensor, comprising:
a light-emitting element configured to emit light to a light emitted surface;
a first light-receiving element and a second light-receiving element configured to receive reflection light from the light emitted surface, the reflection light receiving light emitted from the light-emitting element and reflected at the light emitted surface;
a circuit board including a mounting surface on which the light-emitting element, the first light-receiving element and the second light-receiving element are mounted; and
a housing fixed to the circuit board,
wherein the reflection light enters the first light-receiving element and the second light-receiving element from the light emitted surface without passing through a lens,
wherein optical axes of the light-emitting element, the first light-receiving element, and the second light-receiving element are perpendicular to the mounting surface; and
wherein the housing includes light shielding portions provided between the light-emitting element and the first light-receiving element and between the light-emitting element and the second light-receiving element.

11. An optical sensor according to claim 10, wherein the light shielding portions are respectively engaged with a hole formed in the circuit board at a position between the light-emitting element and the first light-receiving element and a hole formed in the circuit board at a position between the light-emitting element and the second light-receiving element.

12. An optical sensor according to claim 10,
wherein the first light-receiving element is configured to receive regular reflection light of the reflection light; and
wherein the second light-receiving element is configured to receive diffused reflection light of the reflection light.

13. An image forming apparatus comprising:
an optical sensor according to claim 10; and
a light emitted surface,
wherein the optical sensor is configured to detect a toner on the light emitted surface
wherein at least a density of the toner on the light emitted surface or a timing at which the toner passes along the light emitted surface is detected based on an output from the optical sensor.

14. An optical sensor, comprising:
a light-emitting element configured to emit light to a light emitted surface;
a first light-receiving element configured to receive regular reflection light from the light emitted surface, to which the light is emitted from the light-emitting element;
a second light-receiving element configured to receive diffused reflection light from the light emitted surface, to which the light is emitted from the light-emitting element; and
a circuit board including a mounting surface on which the light-emitting element, the first light-receiving element, and the second light-receiving element are mounted,
wherein a light-emitting surface of the light-emitting element, a light-receiving surface of the first light-receiving element, and a light-receiving surface of the second light-receiving element are parallel to the mounting surface;
wherein the mounting surface of the circuit board is inclined with respect to a planar surface including the light emitted surface, and
wherein among a normal line to the planar surface from the light-emitting surface of the light-emitting element, a normal line to the planar surface from the light-receiving surface of the first light-receiving element, and a normal line to the planar surface from the light-receiving surface of the second light-receiving element, the normal line to the planar surface from the light-receiving surface of the second light-receiving element has a smallest length.

15. An optical sensor according to claim 14, wherein the light-emitting element, the first light-receiving element, and the second light-receiving element are arranged in a row in an order of the light-emitting element, the first light-receiving element, and the second light-receiving element in a condition in which L1 is larger than L2 and L2 is larger than L3,
where L1 is a length of the normal line to the planar surface from the light-emitting surface of the light-emitting element, L2 is a length of the normal line to the planar surface from the light-receiving surface of the first light-receiving element, and L3 is a length of the normal line to the planar surface from the light-receiving surface of the second light-receiving element.

16. An optical sensor according to claim 14, wherein an angle between the mounting surface of the circuit board and the planar surface is equal to or smaller than 22 degrees.

17. An optical sensor according to claim 14, wherein the light-emitting element, the first light-receiving element, and the second light-receiving element are arranged in a row in an order of the first light-receiving element, the light-emitting element, and the second light-receiving element in a condition in which L2 is larger than L1 and L1 is larger than L3,
where L1 is a length of the normal line to the planar surface from the light-emitting surface of the light-emitting element, L2 is a length of the normal line to the planar surface from the light-receiving surface of the first light-receiving element, and L3 is a length of the normal line to the planar surface from the light-receiving surface of the second light-receiving element.

18. An optical sensor according to claim 17, wherein an angle between the mounting surface of the circuit board and the planar surface is equal to or smaller than 40 degrees.

19. An image forming apparatus comprising:
an optical sensor according to claim 14; and
a light emitted surface,
wherein the optical sensor is configured to detect a toner on the light emitted surface
wherein at least a density of the toner on the light emitted surface or a timing at which the toner passes along the light emitted surface is detected based on an output from the optical sensor.

20. An image forming apparatus according to claim 5, wherein the target emission surface comprises an endless belt configured to form a toner image thereon.
